(19) United States
(12) Patent Application Publication
(10) Pub. No.: US 2025/0299068 A1
(43) Pub. Date: Sep. 25, 2025

(54) SYSTEMS AND METHODS FOR INTELLIGENTLY COMPILING RESPONSES FROM AI SYSTEMS

(71) Applicant: Wells Fargo Bank, N.A., San Francisco, CA (US)

(72) Inventors: Anjeet Kumar, Bangalore (IN); Rameshchandra Bhaskar Ketharaju, Hyderabad (IN)

(21) Appl. No.: 18/613,008

(22) Filed: Mar. 21, 2024

(51) Int. Cl. G06N 5/022

(52) U.S. Cl. CPC G06N 5/022

(57) ABSTRACT

Systems, apparatuses, methods, and computer program products are disclosed for compiling AI system outputs into unified responses. An example method includes receiving response data that is representative of one or more AI system outputs. The example method further includes identifying a task request associated with the response data. The example method further includes generating a unified response associated with the task request. The example method further includes causing transmission of the unified response to a user device associated with the task request. The example method may further include determining an AI system server that transmitted the response data.

### BACKGROUND

Artificial Intelligence (AI) systems are capable of performing tasks that previously required a human being to perform. Generative Artificial Intelligence (GenAI) systems may use specialized models capable of producing written works, images, audio, and videos in response to prompts provided by a user. Large Language Models (LLMs) are language based models capable of general-purpose written language generation such as drafting emails. Other GenAI systems may be specialized for particular tasks such as generating source code for new computer programs or generating image files depicting a particular scene.

### BRIEF SUMMARY

Many entities (e.g., individuals, banks, financial institutions, retailers, or the like) may integrate AI systems into their daily activities to streamline tedious daily tasks. For example, a manager may utilize an LLM to quickly draft weekly emails tailored to each of their individual employees based on their upcoming work schedule. Such entities may further lean on specialized AI systems to perform more complex tasks that would otherwise require resource intensive specialized services. For example, an architect may utilize a GenAI system to produce concept art for a presentation on a new building. The concept art may be based on the architect's initial design requirements, the architect's sketches, and/or other input data from the architect. In addition, financial advisors may utilize GenAI systems to model theoretical changes to the stock market based on various outcomes for real-world current events (e.g., corporate mergers, military operations, passing of new laws, etc.).

Traditionally, it has been difficult for users, or entities, to track emerging AI systems and to know which general or specialized tasks those AI systems perform most efficiently and/or effectively. For example, choosing the most optimized AI system (e.g., GenAI model, LLM, artificial neural network, Machine Learning (ML) model, or the like) for a particular task presents a challenge because there are a large number of AI systems to choose from and that number is expanding as new versions and new systems are developed. This problem is further compounded because each of these AI systems are associated with their own strengths and weaknesses. In order to make an informed decision, a user of conventional systems would have to possess a deep understanding of each available AI system along with a clear understanding of the unique requirements for utilizing each system effectively (e.g., prompting, uploading data, available computational resources, etc.). For example, not only would a user have to understand the strengths and weaknesses of a particular AI system but the user would also have to know the current computational and/or resource demands (e.g., current request queue, network traffic, processing availability, etc.) placed on that system compared to other available AI systems.

In addition, larger or more complex tasks can present other unique problems for conventional systems and/or techniques because these types of tasks comprise various subtasks which cannot be performed by a single AI system. To this end, conventional system users must subjectively and manually select an AI system for each unique subtask and understand how to properly prompt each selected AI system for that particular subtask. Conventional systems and techniques do not provide a way for users to objectively breakup larger tasks into individual components which may be carried out more efficiently, and/or effectively, by different AI systems. For example, requesting a presentation slideshow may require multiple AI systems to generate detailed textual information and images (e.g., concept art, graphs, etc.). Traditionally, a user would have to subjectively select and prompt each specialized AI system (e.g., an LLM for text, another GenAI for images, etc.) individually and then subjectively and manually compile the resulting text and images into a slideshow presentation.

It should be understood that conventional systems and/or techniques depend upon the subjective human judgment of the user to manually track each available AI system and to determine which system they perceive may optimize the task at hand. For instance, a computer programmer may rely on an LLM to generate simple program code because they are unaware of a GenAI system specialized for creating program code. Additionally, or alternatively, conventional systems and/or techniques do not provide a user or entity insight for determining the current computational and/or resource demands placed on particular AI system (e.g., during a given time period). Further, computational and/or resource demands may fluctuate constantly or periodically between different available AI systems and a user may be unable to measure these fluctuations. For example, in the morning a first AI system may have more bandwidth for user requests than a second AI system and in the afternoon the second AI system may have more bandwidth. Accordingly, subjective human judgment is often informed by unknown subjective bias (e.g., perceived AI system performance instead of empirical AI system performance) and/or outdated information (e.g., in the case of fluctuating bandwidth availability).

Moreover, conventional systems and/or techniques traditionally do not give entities oversight over which AI systems their employees are utilizing and/or what types of sensitive data (e.g., Personally Identifiable Information (PII), proprietary information, trade secrets, Client Confidential Information (CCI), or the like) their employees may be sharing with these AI systems. These entities may be relying on the subjective human judgment of their employees to use approved AI systems and/or to ensure data security. Because subjective human judgment may be misinformed, biased, and/or acting in self-interest, the employee may knowingly or unknowingly violate policies, regulations, or laws restricting the use particular AI systems (e.g., hosted outside of an approved geographical region) and/or restricting the sharing of sensitive data (e.g., PII, CCI, proprietary information, trade secrets, or the like).

In contrast to conventional systems and/or techniques for subjectively selecting AI systems to perform particular tasks, example embodiments described herein provide a smart routing system for optimizing the routing of tasks to AI systems based on objective metrics. According to some example embodiments described herein, the smart routing system may comprise a request receiver, a smart router, and/or a smart compiler. The request receiver may receive incoming task requests from a user, analyze the incoming task requests, and/or segment the task request into discrete and/or separately executable subtask requests in order to make the overall task request more digestible for the smart router and/or any target AI systems. For example, a text-based request may be segmented into keywords, tagged with metadata identifying each type of subtask, and each subtask may be prioritized (e.g., based on a required order of operation, subtask complexity, or the like) before the request is passed to the smart router. In some example embodiments, the request receiver may perform one or more of user authentication, logging request or system metric data, generating metric reports, scanning for malicious data, or filtering out task requests (e.g., based on missing or corrupt data, a lack of authorization or authentication, and/or the like).

The smart router may receive one or more subtask requests (or the task request, e.g., with subtasks identified by metadata or the like) after the completion of preprocessing by the request receiver component. In some examples, the smart router may comprise the request receiver. The smart may determine which one or more AI systems, and/or particular server(s) thereof, are best suited (or most optimized) for each subtask request. Example embodiments of the smart router may accomplish this by weighing various aspects of each task request, subtask request, and/or AI system, such as available AI system computational resources, AI system specializations, network traffic, overall task or individual subtask requirements, and/or the like. For example, the smart router may route subtask requests to one or more AI systems based on language compatibility, security and compliance requirements, and/or real-time (or near-real-time) monitoring (e.g., current AI system load/demand, a server goes offline). The smart router may dynamically route (or re-route) whole task requests and/or individual subtask requests to minimize computational resource usage and/or balance server loads (e.g., to AI systems) in order to optimize the overall task and/or subtask response performance. For instance, similar subtask requests may be sent to different AI systems to prevent overloads (or bottlenecking) at a single AI system. In some example embodiments, the smart router may utilize a feedback loop process to refine future routing decisions and/or routing strategies based on current AI system and/or routing metrics (e.g., response time, user satisfaction with a response, and/or the like).

According to some example embodiments described herein, the smart router may select and/or transmit one or more task requests or subtask requests to one or more AI systems (and/or particular server(s) thereof). In such examples, the AI systems may provide response data back to the smart compiler which may collect any or all response data provided from the AI systems. In some examples, the smart compiler may integrate discrete and/or separate response data into a coherent unified response which the smart compiler may return to the user that initiated the task request. In some examples, the smart compiler may perform operations to validate response data, generate error notifications (e.g., related to failed responses, incomplete response data, and/or the like), restore missing contextual data (e.g., sensitive data and/or the like not transmitted to an AI system), secure or encrypt response data, and/or provide language translation.

Moreover, the smart routing system, as described herein, may be further incorporated with various entity systems (e.g., corporate networks, consumer banking databases, stock market data, inventory tracking systems, etc.) so that the smart routing system may leverage (i) multimodal data to process task requests, (ii) remote (e.g., cloud hosted, etc.) and/or localized (e.g., on-premises, integrated into the smart routing system, etc.) AI systems, and/or (iii) network and/or computing infrastructure for monitoring and securing sensitive data.

Accordingly, the present disclosure sets forth systems, methods, and apparatuses that provide improved systems and techniques for selecting AI systems to perform particular tasks. There are many advantages of these, and other, embodiments described herein over the conventional systems described above.

One advantage is that example embodiments provide an improvement to the functioning of the computing infrastructure of an entity by reducing the burden on computing resources. Example embodiments may accomplish this by providing a central access point (e.g., software program, server, etc.) for users (e.g., employees of a corporate entity, etc.) to enter and distribute task requests to various AI systems and, thus, reduce the burden on the available computing infrastructure associated with system redundancies caused by various users having to simultaneously access the same and/or different AI systems. Moreover, less computing resources are required to monitor a central access point to ensure that (i) only approved AI systems are utilized (e.g., based on geolocation, laws, regulations, etc.), and/or (ii) sensitive data is not improperly shared.

Another advantage is that example embodiments provide an improvement to routing system technologies and/or AI system technologies by maintaining computational profiles for various AI systems which can be leveraged for objective (e.g., empirically based, etc.) AI system selection. Example embodiments may accomplish this by compiling information related to each systems hardware (e.g., server models, etc.), software (e.g., Operating System (OS), computing environment, etc.), available computational resources (e.g., processing power, network capacity, etc.), and/or the like. Example embodiments may accomplish this by monitoring (e.g., periodically, in real-time, near-real-time, etc.) the current demand placed on AI systems (e.g., current request queue, current network usage, estimated response times, etc.). Moreover, example embodiments may accomplish this by utilizing computational profiles to (i) objectively determine which AI systems are approved for use (e.g., based on corporate policy, laws, regulations, particular task types, and/or the like) and/or (ii) objectively determine which sensitive data may be or may not be shared with particular AI systems.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a smart routing system.

FIG. 2 illustrates a schematic block diagram of example circuitry embodying a smart routing system device that may perform various operations in accordance with some example embodiments described herein.

FIG. 3 illustrates a schematic block diagram of example circuitry embodying a user device and/or AI system that may perform various operations in accordance with some example embodiments described herein.

FIG. 4 illustrates a schematic block diagram of example request receiver circuitry that may perform various operations in accordance with some example embodiments described herein.

FIG. 5 illustrates a schematic block diagram of example smart router circuitry that may perform various operations in accordance with some example embodiments described herein.

FIG. 6 illustrates a schematic block diagram of example smart compiler circuitry that may perform various operations in accordance with some example embodiments described herein.

FIG. 7 illustrates an example flowchart for routing task requests and/or subtask requests, in accordance with some example embodiments described herein.

FIG. 8A illustrates an example flowchart for receiving task requests, in accordance with some example embodiments described herein.

FIG. 8B illustrates an example flowchart for determining computational capabilities associated with AI systems, in accordance with some example embodiments described herein.

FIG. 8C illustrates an example flowchart for matching task requests with AI systems, in accordance with some example embodiments described herein.

FIG. 9 illustrates an example flowchart for compiling various response data into a unified response, in accordance with some example embodiments described herein.

FIG. 10A illustrates an example flowchart for receiving various response data, in accordance with some example embodiments described herein.

FIG. 10B illustrates an example flowchart for processing a failed response, in accordance with some example embodiments described herein.

FIG. 10C illustrates an example flowchart for generating a unified response, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “Artificial Intelligence (AI) system” or “AI system” refers to any computing device, server, and/or computing network comprising one or more of a Generative Artificial Intelligence (GenAI) model, Large Language Model (LLM), artificial neural network, Machine Learning (ML) model, and/or any other AI algorithms, models and/or applications (as described herein).

The term “task request” refers to any input that is representative of instructions to execute an actionable task. A task request may comprise one or more subtask requests. The term “subtask request” may refer to any or all components of a task request that are representative of instructions to execute at least part of an actionable task (i.e., an actionable subtask). For example, a task request may include a request to generate an image with a caption. In such examples, the task request may be segmented into two subtask requests, a first subtask that requests the generation of an image and a second subtask that requests the generation of a caption (e.g., textual description) of the image. Example task requests (or subtask requests) may include, without limitation, one or more of a written request (e.g., text data, etc.), spoken request (e.g., voice recording data, etc.), a data retrieval task (e.g., to execute a web search, a Boolean based logic search of a database, etc.), a data modification task (e.g., to organize raw data according to a shared parameter, etc.), a data generation task (e.g., to generate text, an image, a video, etc.), a data verification task (e.g., to encrypt data, decrypt data, authenticate data, etc.) an AI system type (e.g., an LLM, a specialized coding GenAI, video GenAI, image GenAI, and/or the like), or the like as described herein. In some examples, a task request, subtask request, or the like may comprise a prompt for an AI system.

The term “prompt” or “AI prompt” refers to any information (e.g., data object, text, audio, or the like) representative of instructions to an AI system. For example, an AI prompt may be a natural language text command or request that a user provides to an AI system (e.g., LLM, etc.) to generate an output (e.g., response data, etc.). Example AI prompts may comprise, without limitation, one or more of programming language commands, codes, statements, words, numbers, training data, contextual data (e.g., specific context necessary to generate a story, empirical data to generate charts, tables, graphs, and/or the like as described herein) or any other instructions or data (e.g., defining a particular structured format for unstructured data, etc.) necessary for an AI system to execute a task.

The term “response data” or “AI system output” refers to any output generated by an AI system in response to any input (e.g., prompt, task request, subtask request, batch file, and/or the like as described herein). For example, a GenAI system specialized for image generation may receive a task request requesting that the GenAI system “Generate a color image of a red car.” In response, the GenAI system may generate an image file picturing a red car driving down a highway. It will be understood that an AI system may generate response data at various levels of specificity or resolution based on the amount of detail (or context) provided by a task request, subtask request, or input prompt. Using the previous example, if the request specified that the red car should be parked then the image file may have shown the car stationary next to a parking meter or in a driveway instead of driving down a highway. The output or response data of an AI system may vary depending on what type of model (e.g., artificial neural network, etc.) and/or training data is used. For example, an image GenAI may be unable to produce coherent or intelligible natural language and an LLM may be unable to produce images, video, or audio outputs. Examples of response data may include, without limitation one or more of a prediction (e.g., based on financial data and/or other input parameters, Person A will or will not default on a loan), a recommendation (e.g., based on user preferences and/or historical data about a user, the user would like a particular piece of media, such as a news article, song, movie, etc.), a classification (e.g., a particular email is spam, a data object contains malicious code, image A is an animal while image B is a vehicle, etc.), an image file or data object (e.g., JPEG, GIF, TIFF, RAW, etc.), a video file or data object (e.g., MPG, MP4, MOV, etc.), an audio file or data object (e.g., MP3, WAV, etc.), a text file or data object (e.g., TXT, DOCX, chatroom response, etc.), a particular structured format, a slideshow presentation (e.g., combining images, charts, text, video, and/or the like), or any other output that can be produced by an AI system as described herein.

The term “unified response” or “unified response data” refers to any output generated by example embodiments as described herein (e.g., in response to task request from a user device). In some examples, a unified response may comprise one or more AI system outputs (or response data) provided by one or more AI systems and/or one or more AI system servers. For example, a unified response may comprise a financial graph or chart output by a first AI system and a written explanation of the financial graph (e.g., data therein, observable trends, future predictions based on the graph or chart, etc.) output by a second AI system. As another example, a unified response may comprise a financial graph or chart and/or a written explanation of data output by a single AI system (e.g., using the same or different servers for each output). In some such examples, the unified response may include additional data not included in the response data (or output) of the AI system. For example, the unified response may include sensitive data while the output of the AI system may include substitute or synthetic data (as will be described in further detail below).

### System Architecture

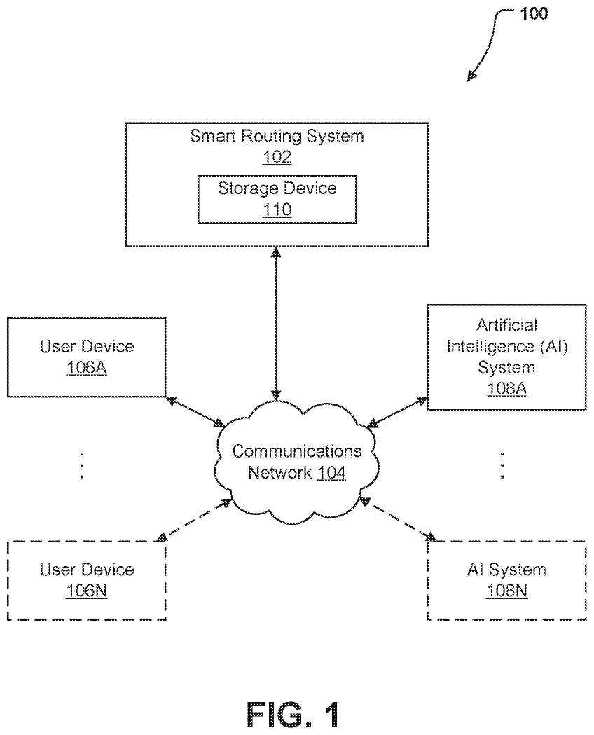

Example embodiments described herein may be implemented using any of a variety of computing devices or servers. To this end, FIG. 1 illustrates an example environment 100 within which various embodiments may operate. As illustrated, a smart routing system 102 may receive and/or transmit information via communications network 104 (e.g., the Internet, and/or the like) with any number of other devices, such as one or more of user devices 106A-106N and/or AI systems 108A-108N.

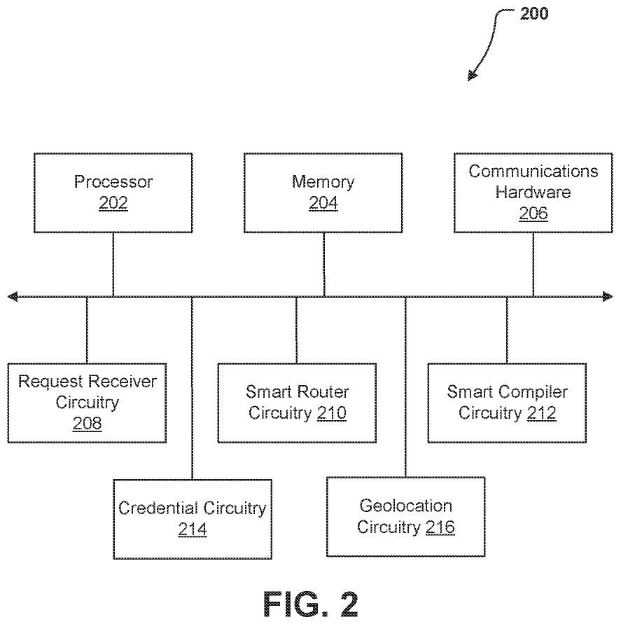

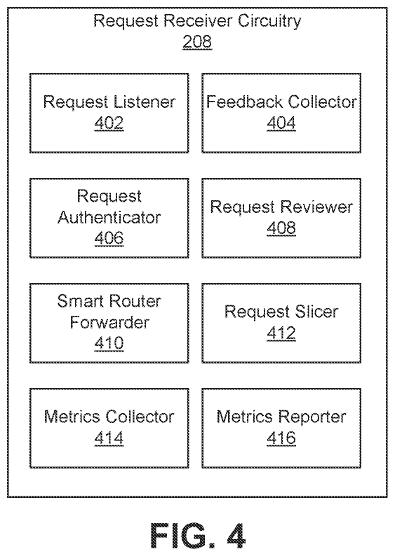

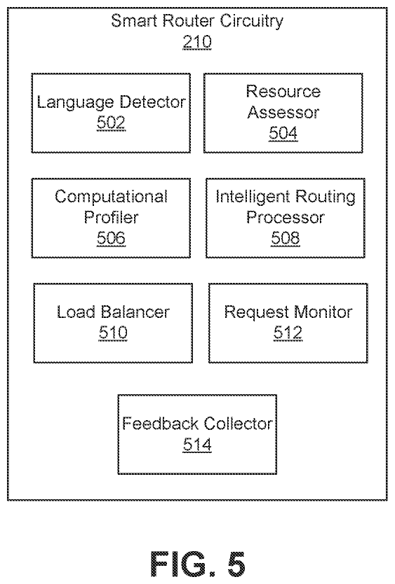

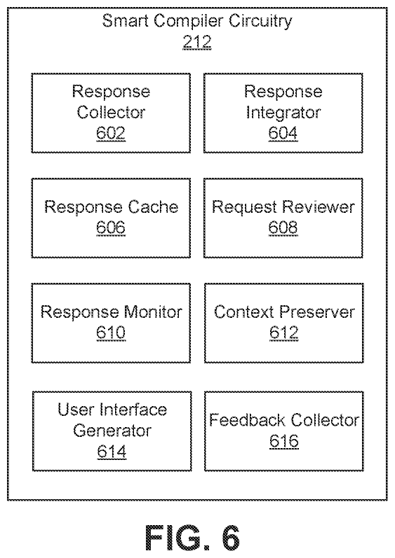

The smart routing system 102 may be implemented as one or more computing devices and/or servers, which may be composed of a series of components. Particular components of the smart routing system 102 are described in greater detail below with reference to apparatus 200 in connection with FIG. 2, request receiver circuitry 208 in connection with FIG. 4, smart router circuitry 210 in connection with FIG. 5, and smart compiler circuitry 212 in connection with FIG. 6. In some examples, the smart routing system 102 (and/or any component associated with the smart routing system 102 as described below in connection with apparatus 200) may be integrated with (or using) one or more Integrated Development Environments (IDEs), Continuous Integration (CI) pipelines, and/or Continuous Development (CD) pipelines in order to facilitate use of the smart routing system 102 (e.g., without drastically altering an entities existing workflow).

In some embodiments, the smart routing system 102 further includes a storage device 110 that comprises a distinct component from other components of the smart routing system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the smart routing system 102. Storage device 110 may store information relied upon during operation of the smart routing system 102, such as various computational profiles associated with AI systems (e.g., any of the AI systems 108A-108N) that may be generated and/or used by the smart routing system 102, data and documents (e.g., corporate policies, sensitive data handling protocols, and/or the like) to be analyzed using the smart routing system 102, and/or the like. In addition, storage device 110 may store control signals, device characteristics (e.g., Operating System (OS), Internet Protocol (IP) Address, and/or the like), and/or access credentials (e.g., security certificates, passwords, handshake protocols, and/or the like) enabling interaction between the smart routing system 102 and one or more of the user devices 106A-106N or the AI systems 108A-108N.

The one or more user devices 106A-106N and the one or more AI systems 108A-108N may be embodied by any computing devices known in the art. The one or more user devices 106A-106N and the one or more AI systems 108A-108N need not themselves be independent devices but may be peripheral devices communicatively coupled to other computing devices.

Although FIG. 1 illustrates an environment and implementation in which the smart routing system 102 interacts indirectly with a user via one or more of user devices 106A-106N and/or AI systems 108A-108N, in some embodiments users may directly interact with the smart routing system 102 (e.g., via a user interface and/or communications hardware of the smart routing system 102) and/or the smart routing system 102 may comprise one or more AI systems, in which case one or more separate user devices 106A-106N and/or one or more separate AI systems 108A-108N may not be utilized. Whether by way of direct interaction or indirect interaction via another device, a user may communicate with, operate, control, modify, or otherwise interact with the smart routing system 102 to perform the various functions and achieve the various benefits described herein.

### Example Implementing Apparatuses

The smart routing system 102 (described previously with reference to FIG. 1) may be embodied by one or more computing devices or servers, shown as apparatus 200 in FIG. 2. The apparatus 200 may be configured to execute various operations described above in connection with FIG. 1 and/or below in connection with FIGS. 4-7, 8A-8B, 9, and 10A-10C. As illustrated in FIG. 2, the apparatus 200 may include processor 202, memory 204, communications hardware 206, request receiver circuitry 208, smart router circuitry 210, smart compiler circuitry 212, geolocation circuitry 216, and credential circuitry 214, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor 202 for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include one or more of a keyboard, mouse, touch screen, touch area, soft key, microphones, speaker, light (e.g., light emitting diode (LED), etc.), and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

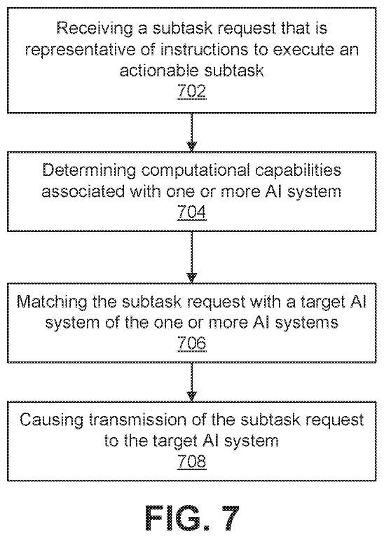

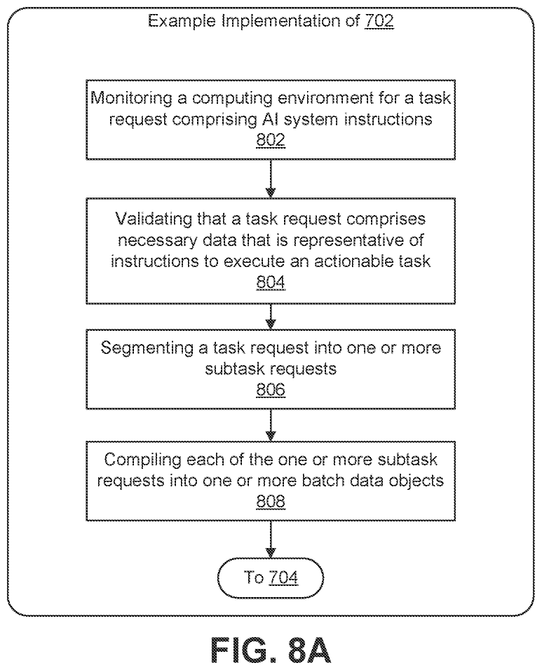

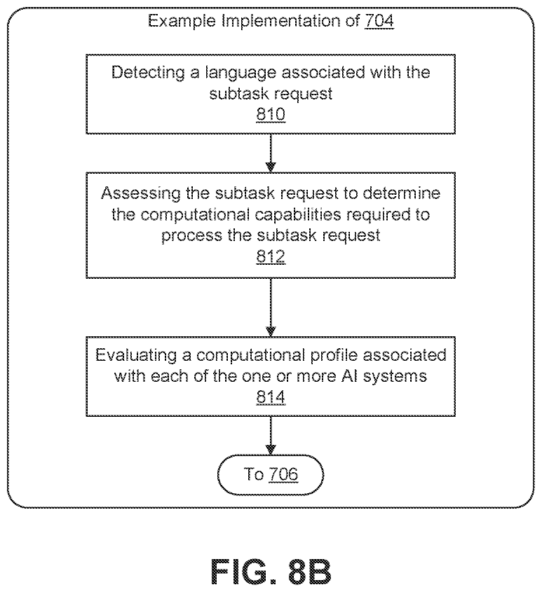

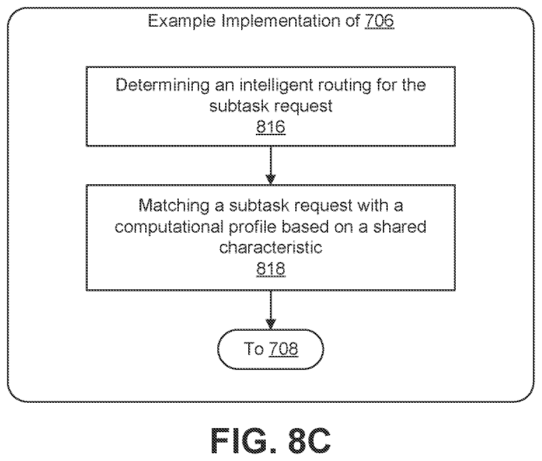

In addition, the apparatus 200 further comprises request receiver circuitry 208 that may be any means such as a device or circuitry embodied in either hardware or a combination of hardware and software that is configured to receive a task request (e.g., from a user via communications hardware 206 and/or the like) and/or analyze the task request for further processing by the smart router circuitry 210. The request receiver circuitry 208 may utilize processor 202, memory 204, or any other hardware component included in the apparatus 200 to perform these operations which are described in greater detail below in connection with FIGS. 7 and 8A.

The request receiver circuitry 208 will now be described in further detail below with reference to FIG. 4. As illustrated in FIG. 4, the request receiver circuitry 208 may include request listener 402, feedback collector 404, request authenticator 406, request reviewer 408, smart router forwarder 410, request slicer 412, metric collector 414, and/or metric reporter 416, each of which may be embodied as hardware (e.g., application specific interface circuit (ASIC) and/or the like as described herein) and/or software instructions (e.g., algorithms and/or the like as described herein).

In some examples, the request receiver circuitry 208 may utilize the request listener 402 to monitor a computing environment, such as communication channels communicatively coupled to the communications hardware 206, for incoming task requests and/or user inputs. For example, the request listener 402 may listen to one or more network ports communicatively coupled to the user devices 106A-106N for incoming task requests.

In some examples, the request receiver circuitry 208 may utilize the feedback collector 404 to log incoming task requests. For example, the request listener 402 may identify an incoming task request and pass the task request (e.g., or a data object associated therewith) to the feedback collector 404. Further, the feedback collector 404 may generate log entry data in a log database (e.g., of storage device 110 and/or the like) comprising the task request, a timestamp (e.g., indicating a time of receipt and/or the like), and/or a request origin (e.g., user that made the request, device that transmitted the request, and/or the like).

In some examples, the request receiver circuitry 208 may utilize the request authenticator 406 to authenticate and/or validate incoming task requests. For example, the request authenticator 406 may process an incoming task request determine that each request is associated with an authentic and authorized user and/or user device. The request authenticator 406 may leverage some or all of the functions described below in connection with credential circuitry 214. In some examples, the request authenticator 406 may allow authentic and authorized task requests, and/or block inauthentic or unauthorized task requests, for further processing. The authentication and/or authorization status of a task request may be logged by the feedback collector 404.

In some examples, the request receiver circuitry 208 may utilize the request reviewer 408 to validate the data associated with task requests. For example, the request reviewer 408 may determine whether a task request has all the necessary components and that the task request is formatted correctly (e.g., for an associated AI system, etc.). In some examples, the request reviewer 408 may remove (e.g., strip out, delete, etc.) unnecessary data and/or redundant data from the task request to facilitate faster processing, such as by the smart router circuitry 210. In some examples, the request reviewer 408 may include virus and/or malware detection software for scanning and/or sanitizing a task request. For example, the request reviewer 408 may scan incoming task requests for harmful or malicious code (e.g., computer viruses, trojan horses, ransomware, and/or the like) and then isolate or remove the harmful or malicious code. The sanitization status of a task request may be logged by the feedback collector 404.

In some examples, the request reviewer 408 may categorize a task request based on the content of the task request (e.g., by applying metadata, tag data, and/or the like to the task request). For example, a task request may represent a request by a user for an image of an animal and the request reviewer 408 may associate tag data, indicating a data generation task (e.g., an image generation task), to the task request. The applied or associated tag data (or the like) of a task request may be logged by the feedback collector 404. In some examples, the request reviewer 408 may filter sensitive data from a task request, such as by deleting the sensitive data and replacing any necessary sensitive data (e.g., required to perform the requested task) with synthetic data. For example, a task request may include a user's name (or other PII) and the request reviewer 408 may replace the user's actual name with a generic placeholder name (e.g., John Doe, Jane Doe, User One, etc.) or other synthetic data. The filtered sensitive data of a task request may be logged by the feedback collector 404 (e.g., for use by the context preserver 612 of the smart compiler circuitry 212). In some examples, the request reviewer 408 may generate and/or retrieve synthetic data (e.g., from storage device 110 or the like) to replace sensitive data.

In some examples, the request receiver circuitry 208 may utilize the smart router forwarder 410 to forward task requests processed by the request receiver circuitry 208 to the smart router circuitry 210. For example, after completion of processing of a task request by one or more of request listener 402, feedback collector 404, request authenticator 406, request reviewer 408, request slicer 412, metric collector 414, and/or metric reporter 416, the smart router forwarder 410 may transmit a processed task request to the smart router circuitry 210. In some examples, the smart router forwarder 410 may package (e.g., in a batch file or the like) one or more subtask requests (e.g., generated by the request slicer 412) together before transmitting them to the smart router circuitry 210. In some examples, the request reviewer 408 may ensure each subtask request is packaged (e.g., in a batch file or the like) with all necessary data to be actionable (e.g., executable by an AI system). In some examples, similar types of subtask requests (e.g., data retrieval subtasks, data generation subtask, etc.) may be packaged (or batched) together (e.g., to improve efficiency at the smart router circuitry 210 and/or reduce network traffic or other burdens on computing resources). In some examples, (e.g., if the request receiver circuitry 208 is associated with a different apparatus (e.g., apparatus 200) then the smart router circuitry 210) the smart router forwarder 410 may utilize the communications hardware 206 to establish a secure and reliable connection to the smart router circuitry 210.

In some examples, the smart router forwarder 410 may listen for a reply from the smart router circuitry 210 to ensure that any or all subtask requests (or batch files) were received. For example, the smart router forwarder 410 may receive acknowledgment from the smart router circuitry 210 that the subtask request has been received and/or will be acted upon by the smart router circuitry 210. If a confirmation of receipt for any or all subtask requests (or batch files) is not received by the smart router forwarder 410 then the smart router forwarder 410 may retransmit the unacknowledged subtask requests (or batch files). For example, the smart router forwarder 410 may attempt to retransmit the unacknowledged subtask requests (or batch files) a number of times (e.g., 3 retries, or any other number). The transmission status (e.g., successful or unsuccessful receipt, network errors, computing errors, etc.) of a subtask request (or batch file) may be logged by the feedback collector 404. The transmission status (e.g., successful or unsuccessful receipt, network errors, computing errors, etc.) of a subtask request (or batch file) may be reported by the metric reporter 416 (e.g., via an alert, such as an email, push notification, or the like, to a user interface of a user device).

In some examples, the request receiver circuitry 208 may utilize the request slicer 412 to segment or parse task requests. For example, a complex task request may require execution of various subtasks and the request slicer 412 may segment or parse the complex task request into a plurality of discrete subtask requests (e.g., based on available AI system functionality and/or other metrics). Each discrete subtask request may represent a data retrieval subtask (e.g., to execute a web search, a Boolean based logic search of a database, etc.), a data modification subtask (e.g., to organize raw data according to a shared parameter, etc.), a data generation subtask (e.g., to generate text, an image, a video, etc.), an AI system type (e.g., an LLM, a specialized coding GenAI, video GenAI, image GenAI, and/or the like), and/or the like. In some examples, the request reviewer 408 may further categorize each subtask request (e.g., as a data retrieval subtask and/or the like) based on the content of the subtask request and/or the task request. The request slicer 412 may comprise one or more parsing algorithms and/or the like. In some examples, the request slicer 412 may prioritize or order the subtask requests. For example, if the user requests a written explanation of data (e.g., stock market prediction, financial plan, news article, story, etc.) with images, the request slicer 412 may generate a first subtask request for the written explanation to an LLM and one or more second subtask requests for images based on the data in the written explanation. In such examples, a story would have to be provided by an LLM before images based on the story could be provided by a specialized image GenAI, therefore the first subtask request would be prioritized ahead of the second subtask request(s).

In some examples, the request receiver circuitry 208 may utilize the metric collector 414 to generate and/or analyze metric data, such as the number of requests (e.g., received, processed, corrupted, incomplete, or the like), slicing efficiency, routing time, user or user device statistics (e.g., number of requests per user or user device), sensitive data violations, and/or the like. In some examples, any or all data logged by the feedback collector 404 may be accessible to the metric collector 414 (e.g., for analysis, such as statistical analysis or the like). The metric collector 414 may transmit (e.g., upon request, in response to a trigger such as detecting sensitive data violations, and/or the like) any or all metric data to the metric reporter 416 for reporting to a user (e.g., via an alert, such as an email, push notification, or the like, to a user interface of a user device).

In some examples, the request receiver circuitry 208 may utilize the metric reporter 416 to generate and/or transmit alerts and/or reports to one or more users (or user devices). For example, if there are any anomalies or issues detected by the request receiver circuitry (or a module thereof) the metric reporter 416 can alert the appropriate entities (e.g., a user, manager, team, apparatus 200, apparatus 300, and/or the like). Examples of anomalies or issues may include, without limitation, one or more of a sensitive data violation, detection of a virus or malware, incomplete or corrupted requests, unauthorized access attempts, high failure rate, and/or the like. In some examples, the metric reporter 416 may generate, periodically or in response to a user request, reports on the performance, efficiency, health, and/or the like of the request receiver circuitry 208.

Turning to FIG. 2, the apparatus 200 further comprises the smart router circuitry 210 that may be any means such as a device or circuitry embodied in either hardware or a combination of hardware and software that is configured to receive one or more of a task request, subtask request, and/or batch file (e.g., from the request receiver circuitry 208, from a user device, and/or the like) and determine a routing for each received request and/or batch file to one or more AI systems. The smart router circuitry 210 may utilize processor 202, memory 204, or any other hardware component included in the apparatus 200 to perform these operations which are described in greater detail below in connection with FIGS. 7 and 8A-8C.

The smart router circuitry 210 will now be described in further detail below with reference to FIG. 5. As illustrated in FIG. 5, the smart router circuitry 210 may include language detector 502, resource assessor 504, computational profiler 506, intelligent routing processor 508, load balancer 510, request monitor 512, and/or feedback collector 514, each of which may be embodied as hardware (e.g., application specific interface circuit (ASIC) and/or the like as described herein) and/or software instructions (e.g., algorithms and/or the like as described herein)

In some examples, the smart router circuitry 210 may utilize the language detector 502 to identify languages associated with task requests, subtask requests, and/or batch files. Examples of languages may include spoken languages, written languages, programming or coding languages, and/or the like. For example, a subtask request may comprise a written request, such as “Generate an image of a tree” and the language detector 502 may parse the written request and identify that the request is written in the English language. In some examples, a task request, subtask request, and/or batch file may include a recorded voice request, in such examples the language detector 502 may utilize speech recognition techniques to identify a spoken language (e.g., English, Japanese, Italian, etc.). In some examples, the language detector 502 may accommodate one or more languages to facilitate single or multi-language processing by the smart router circuitry 210 and/or other modules of apparatus 200. The identified language status of a task request or subtask request may be utilized by the intelligent routing processor 508, and/or any other module of the smart router circuitry 210 to match the request with an AI system. For example, a particular AI system may only be compatible with one or more particular languages.

In some examples, the smart router circuitry 210 may utilize the resource assessor 504 to evaluate computational resources, such as processing power, memory, storage size, and networking associated with task requests, subtask requests, and/or batch files. For example, the resource assessor 504 may evaluate a subtask request based, at least in part, on historic data (e.g., computational profiles, feedback log data, etc.) and/or current data (e.g., content of the request, computational time of each AI system, etc.) in order to determine the computational capabilities (e.g., minimum processing power, memory, etc.) required for a respective AI system to execute one or more actionable tasks of the subtask request. In some examples, the resource assessor 504 may compile a list of AI systems that possess at least the minimum requirements to fulfill one or more task requests and/or subtask requests. The resource assessor 504 may transmit a resource assessment status associated with task request, subtask request, and/or batch file to the computational profiler 506, the intelligent routing processor 508, and/or any other module the smart router circuitry 210. The resource assessment status may indicate the minimum requirements to fulfill one or more task requests (or subtask requests) and/or any associated AI systems that possess the minimum requirements. The resource assessment status may indicate that a particular task or subtask is processor-intensive, memory-intensive (e.g., requires high RAM usage, etc.), network-intensive (e.g., requires high-speed communication network connections, long data transfer periods, etc.), storage-intensive (e.g., requires large available storage space on a HDD, SSD, or the like), power-intensive (e.g., completion of the task/subtask will require excessive power consumption, etc.), and/or the like.

In some examples, the smart router circuitry 210 may utilize the computational profiler 506 to generate and/or maintain a computational profile database (e.g., on storage device 110). The computational profile database may include one or more available AI systems and each AI system may be associated with their respective computational capabilities, routing data (e.g., IP address, etc.) compatible languages (e.g., spoken, written, and/or programming or coding languages), geolocation data (e.g., server location, host country, Global Positioning System (GPS) coordinates, physical address, etc.), Operating System (OS), computing environment type (e.g., mainframe, client-server, cloud computing, etc.), hardware models, and/or any other computational profile data that may be collected by the apparatus 200 in relation to an AI system. In some examples, the computational profiler 506 may leverage the communications hardware 206 to request computational profile data from one or more AI systems in order to maintain the computational profile database (e.g., by adding up-to-date data, removing obsolete data, and/or the like). The computational profiler 506 may request up-to-date computational profile data (e.g., computational capabilities, etc.) from a particular AI system periodically (e.g., daily, weekly, etc.) and/or in real-time (or near-real-time), such as in response to receiving a task request (or subtask request) associated with the particular AI system. Examples of computational capabilities may include, without limitation, processing power, model and/or number of processor cores, model and/or number of Graphics Processing Units (GPUs), memory size (e.g., cache size), memory type (e.g., RAM, etc.), storage (e.g., Solid-State Drive (SSD), Hard Disk Drive (HDD), available space, etc.), current load (e.g., current number of jobs, current processing queue, etc.), future load (e.g., expected wait time, expected availability, scheduled downtimes for maintenance, etc.), and/or the like.

In some examples, the smart router circuitry 210 may utilize the intelligent routing processor 508 to match a task request, subtask request, and/or batch file with one or more AI systems. In some examples, the intelligent routing processor 508 may leverage the communications hardware 206 to cause transmission of a task request, subtask request, and/or batch file with one or more AI systems (e.g., based on data provided by the language detector 502, the resource assessor 504, the computational profiler, the load balancer, the request optimizer, and/or any other module of the smart router circuitry 210). The intelligent routing processor 508 may match one or more requests with one or more AI systems based on the particular data associated with each of the request(s), the AI system(s), and/or a relationship therebetween. For example, intelligent routing processor 508 may match a subtask request with an AI system based, at least in part, on the resource assessment status of the request, the computational profile data of the AI system, and/or a relationship therebetween (e.g., a compatibility ratio of the minimum requirements to fulfill the request(s) and the computational capabilities of a particular AI system). In some examples, the intelligent routing processor 508 may select a plurality of AI systems for a subtask request. For example, the intelligent routing processor 508 may select a first AI system that is most optimized for a particular task and one or more second AI systems that are less optimized for the task. The one or more second AI systems may comprise alternative fallback AI systems (e.g., different from the first AI system) and/or redundant servers of the first AI system. If the selected first AI system (or server) fails to properly execute and/or respond to the subtask request (e.g., the first server becomes unavailable) then the smart router circuitry 210 may transmit (or reroute) the subtask request to the one or more second AI systems (or redundant servers of the first AI system).

In some examples, the first AI system may exceed the minimum requirements to fulfill the request by a higher ratio (e.g., 5 GB of RAM available to 1 GB of RAM required, and/or a ratio based on any other requirements, such as processing power, storage, etc.) than the one or more second AI systems but the one or more second AI systems may still at least meet the minimum requirements (e.g., with a lower ratio of 2 GB of RAM available to 1 GB of RAM required). In some examples, the intelligent routing processor 508 may select a less optimized AI system (e.g., a general-purpose language model, etc.) over a more optimized AI system (e.g., a special-purpose GenAI system, etc.) based on the current loading of each AI system (e.g., the less optimized AI system may have a shorter estimated response time than the more optimized AI system). The intelligent routing processor 508 may receive current and/or future loading data for one or more AI systems from the load balance 510. In some examples, the intelligent routing processor 508 may determine different optimized routing a subtask request to a particular server of an AI system, such as based on current and/or future loading data. In such examples, the intelligent routing processor 508 determine one or more routings to optimize one or more characteristics related to an AI system (or server). For example, a first optimized routing may be associated with the fastest available response time, a second optimized routing may be associated with the lowest cost (e.g., in the case of paid AI systems), a third optimized routing may be associated with the most specialized AI system (e.g., for a particular subtask), and/or the like. In some examples, the intelligent routing processor 508 determines whether an AI system (or a particular server thereof) meets one or more compliance requirements (e.g., laws, regulations, corporate policies, data export requirements, geolocation restrictions, security compliance standards, and/or the like) for handling sensitive data (e.g., PII, CCI, proprietary information, trade secrets, and/or the like).

In some examples, the smart router circuitry 210 may utilize the load balancer 510 to determine current and/or future loading data for one or more AI systems. For example, the load balancer 510 may leverage the communications hardware 206 to request data associated with a current load (e.g., current number of jobs, current processing queue, etc.) and/or future load (e.g., expected wait time, expected availability, scheduled downtimes for maintenance, etc.) from one or more AI systems. Current loading data may represent the instant loading of a server or computing network associated with an AI system, such as at the time the load balancer 510 requested the data. Future loading data may be an estimate (or prediction) of the current loading of a server or computing network associated with an AI system at a future time (e.g., in 1 minute, 10 minutes, 1 hour, or any other time), such as based on the actual current loading and the expected processing time for the current request queue of the AI system. In some examples, the load balancer 510 may assign subtask requests (e.g., similar subtask requests, subtask requests associated with the same original task request, a batch file, etc.) to different AI systems (e.g., to balance the processing of tasks, increase response times, etc.). In some examples, an AI system may comprise a plurality of servers and the load balancer 510 may assign subtask requests (e.g., similar subtask requests, subtask requests associated with the same original task request, a batch file, etc.) to different servers of the same AI system (e.g., to reduce bottlenecking at one server, increase response times, etc.).

In some examples, the smart router circuitry 210 may utilize the request monitor 512 to listen for a reply from one or more AI systems to ensure that any or all task requests, subtask requests, and/or batch files were received. For example, the request monitor 512 may receive acknowledgment from the one or more AI systems that a subtask request has been received and/or will be acted upon by the request monitor 512. If a confirmation of receipt for any or all task requests, subtask requests, and/or batch files is not received by the request monitor 512 then the intelligent routing processor 508 may retransmit (or reroute) the unacknowledged task requests, subtask requests, and/or batch files. For example, the request monitor 512 may cause the intelligent routing processor 508 to retransmit the unacknowledged task requests, subtask requests, and/or batch files a number of times (e.g., 3 retries, or any other number). Further, if an acknowledgment is not received from the first AI system (or first server) by the request monitor 512 after a predefined number for retransmission attempts then the intelligent routing processor 508 may reroute the unacknowledged task requests, subtask requests, and/or batch files to a fallback AI system or a redundancy server of the first AI system. The transmission status (e.g., successful or unsuccessful receipt, network errors, computing errors, number of retransmissions, selected fallback or redundancy, etc.) of a subtask request (or batch file) may be logged by the feedback collector 514. The transmission status (e.g., successful or unsuccessful receipt, network errors, computing errors, number of retransmissions, selected fallback or redundancy, etc.) of a task request, subtask request, and/or batch file may be reported by the request monitor 512 (e.g., via an alert, such as an email, push notification, or the like, to a user interface of a user device).

In some examples, the smart router circuitry 210 may utilize the feedback collector 514 to log outgoing task requests, subtask requests, and/or batch files (e.g., transmitted to AI systems). For example, the feedback collector 404 may generate log entry data in a log database (e.g., of storage device 110 and/or the like) comprising an outgoing request (or batch file), a timestamp (e.g., indicating a time of transmission and/or the like), a request origin (e.g., user that made the request, device that transmitted the request, and/or the like), a destination (e.g., an AI system, server, and/or the like), and/or any other log entry data described herein. In some examples, the feedback collector 514 of the smart router circuitry 210 may comprise, at least in part, the feedback collector 404 of the request receiver circuitry 208. In some examples, the feedback collector 514 and the feedback collector 404 may utilize, at least in part, the same log database or different log databases. In some examples, any or all data logged by the feedback collector 404 may be accessible to the feedback collector 514, and/or vice versa. The feedback collector 514 may generate log entry data indicating feedback on the performance (e.g., of the apparatus 200 to process the request, the response data from the target AI system, and/or the like) and resource consumption used to process the request (e.g., at the apparatus 200 and/or the target AI system). In some examples, log entry data may be used in conjunction with a feedback loop (e.g., machine learning model, artificial neural network, etc.) to refine future routing (or rerouting) decisions, optimization strategies, and/or other operations associated with one or more modules of the smart router circuitry 210.

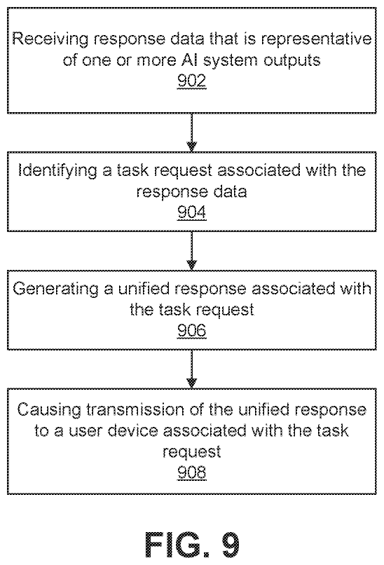

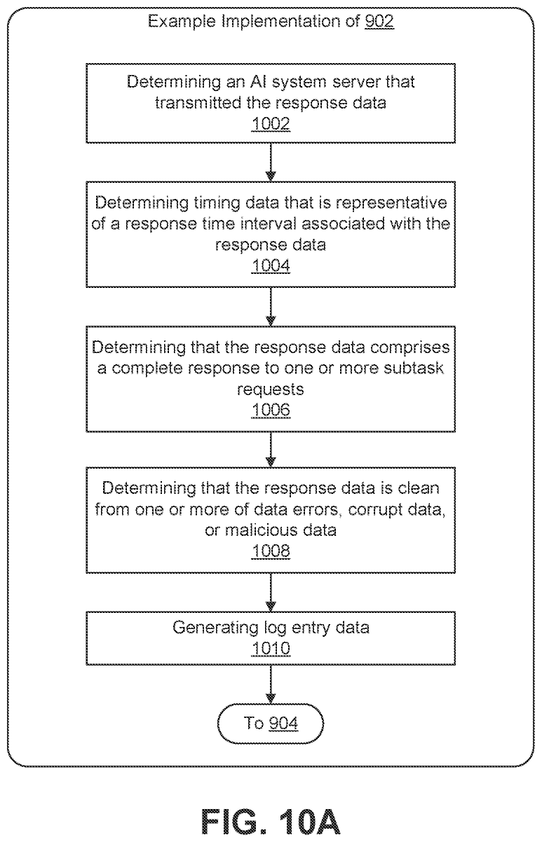

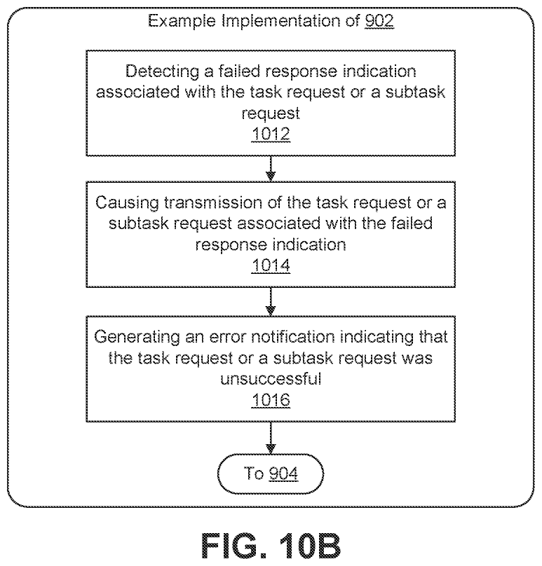

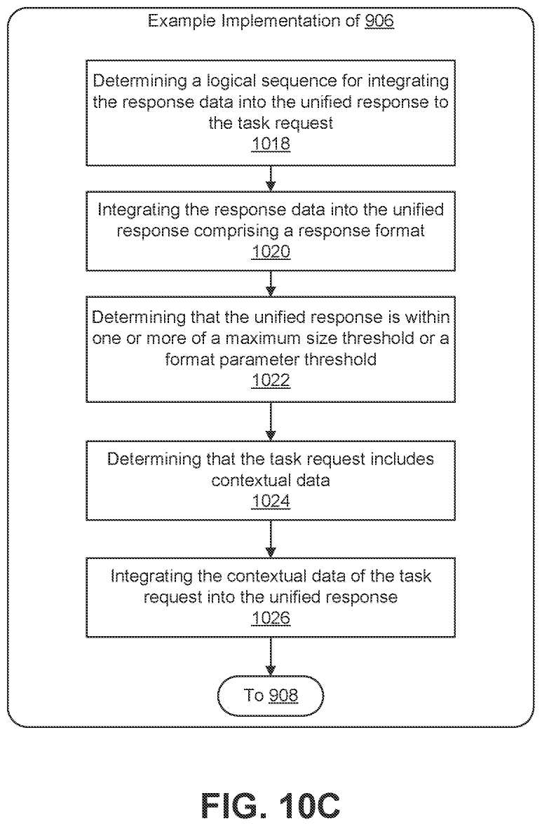

Turning to FIG. 2, the apparatus 200 further comprises the smart compiler circuitry 212 that may be any means such as a device or circuitry embodied in either hardware or a combination of hardware and software that is configured to receive response data (e.g., from one or more AI systems) and generate a unified response to a task request. The smart compiler circuitry 212 may utilize processor 202, memory 204, or any other hardware component included in the apparatus 200 to perform these operations which are described in greater detail below in connection with FIGS. 9 and 10A-10C.

The smart compiler circuitry 212 will now be described in further detail below with reference to FIG. 6. As illustrated in FIG. 6, the smart compiler circuitry 212 may include response collector 602, response integrator 604, response cache 606, request reviewer 608, response monitor 610, context preserver 612, user interface generator 614, and/or feedback collector 616, each of which may be embodied as hardware (e.g., application specific interface circuit (ASIC) and/or the like as described herein) and/or software instructions (e.g., algorithms and/or the like as described herein).

In some examples, the smart compiler circuitry 212 may utilize the response collector 602 to monitor a computing environment, such as communication channels communicatively coupled to the communications hardware 206, for incoming response data and/or any other data provided by AI systems as described herein. For example, the response collector 602 may listen to one or more network ports communicatively coupled to the AI systems 108A-108N for incoming response data, error notifications, and/or any other data provided by AI systems. In some examples, the response collector 602 may identify response data and pass the response data to the feedback collector 616. In some examples, an AI system (e.g., LLM, etc.) server(s) process a subtask request (or the like) individually and transmit the response data (containing the requested results) to the response collector 602 results. In some examples, the response collector 602 collects (e.g., gathers, records, etc.) the response data including metric data (e.g., metadata, etc.) indicating which AI system and/or server(s) processed the subtask request (or the like), which AI system and/or server(s) transmitted the response data, and/or the response time frame (e.g., time of receipt, total processing time, etc.). In some such examples, the response integrator 604 may transmit, at least in part, the metric data to the feedback collector 616.

In some examples, the smart compiler circuitry 212 may utilize the response integrator 604 to incorporate any or all response data (e.g., associated with a task request from a user device) into a unified response. The response integrator 604 may (e.g., upon receipt of some or all response data associated with a task request) validate the integrity (e.g., scan for malicious code, etc.) and completeness (e.g., scan for corrupt or broken data, errors, etc.) of the response data from each AI system and/or each server. For example, the response collector 602 may receive response data from a plurality of AI systems in response to a plurality of subtask requests. Each of the plurality of subtask requests may be associated with a single task request received by the request listener 402 from a user of a user device. In some such examples, the response integrator 604 may generate a unified response (e.g., responding to the single task request) based on the received response data. The response integrator 604 may generate the unified response by, at least in part, merging, appending, and/or combining the multiple AI systems' response data into a coherent unified dataset (e.g., with a particular response format, such as a written response to a user's question, a particular file type requested by the user, and/or the like). In some examples, the response integrator 604 may comprise one or more of a predefined rule set, artificial neural network (or the like), sequencing algorithm, or any other algorithm(s) for determining the nature of a task request and/or integrating any or all response data into a logical sequence to response to the task request. In some examples, the response integrator 604 may apply optimization algorithms (e.g., compression algorithms, etc.) to ensure that the unified response is efficiently compiled (e.g., to minimize any associated data object size(s), increase transmission speed, reduce redundant data such as formatting, increase ease of handing by a user device, and/or the like).

In some examples, the smart compiler circuitry 212 may utilize the response cache 606 to record response data. For example, the response cache 606 may receive and/or store response data collected by the response collector 602 in a database. The response cache 606 may comprise one or more databases and/or memory or storage device partitions for storing the response data. For frequently received task requests (e.g., of a similar type or nature) and/or for predictable response patterns, the smart compiler circuitry 212 may utilize the response cache 606 to accelerate similar future compilations, such as by intelligently determining when to use cached response data instead of using (or waiting for) response data related to a current subtask request. For example, if most of the response data related to a task request has been received and the remaining response data is unavailable (e.g., not received yet, long wait time, corrupt, broken, etc.) then the response integrator 604 may utilize substitute response data previously recorded via the response cache 606 similar to the unavailable response data. For example, the unavailable response data may be associated with the same or similar type of subtask request as the substitute response data.

In some examples, the smart compiler circuitry 212 may utilize the request reviewer 608 to handle missing response data, response data with integrity and/or completeness errors. For example, in the event an AI system or server fails to respond to a subtask request (or the like), returns malicious code, and/or returns an error, then the request reviewer 608 may flag the response data and/or any associated subtask requests (or the like) for rerouting a subtask request to a backup AI system or an AI system backup server, and/or any other fallback mechanism described herein (e.g., using substitute response data from the response cache 606). In some examples, the request reviewer 608 may generate a partial response error notification and/or cause the response integrator 604 to generate a partial unified response (e.g., that only fulfills part of a user's task request). In such examples, the request reviewer 608 may cause the user interface generator 614 to provide the partial response error notification to a user via a user device and/or user interface as described below.

In some examples, the smart compiler circuitry 212 may utilize the context preserver 612 to restore any or all contextual data (e.g., sensitive data, etc.) that may have been removed from a subtask request (or the like) before transmitting the subtask request to an AI system. For example, a user may provide a task request requesting a personal biographic essay and the task request may comprise sensitive data (e.g., personal life details, PII, and/or the like) to assist an AI system to execute the task. In some such examples, the sensitive data may have been removed and replaced with synthetic or substitute data (as described herein). Accordingly, the context preserver 612 may identify the synthetic or substitute data (e.g., in response data and/or in a unified response) and replace the synthetic or substitute data with the original sensitive data (e.g., personal life details, PII, and/or the like) provided by the user. To this end, the context preserver 612 may ensure that the context of the original task request is preserved in the final unified response to the user without compromising the security of the sensitive data.

In some examples, the smart compiler circuitry 212 may utilize the response monitor 610 to capture and/or report periodic, real-time, and/or near-real-time system and/or process monitoring to users and/or system administrators. For example, the response monitor 610 may report to a user (e.g., system administrators, team member, manager, and/or the like) via a real-time view, such as through a graphical user interface, of where a task request, subtask request, and/or batch file is being executed (e.g., at which AI system(s), at which module of the apparatus 200, and/or the like), the resources being utilized for execution, any errors, and/or any performance metrics. In some examples, the response monitor 610 may gather data, for reporting to a user from one or more other components of apparatus 200 (e.g., metrics collector 414, feedback collector 616, and/or any other modules that process or collect data).

In some examples, the smart compiler circuitry 212 may utilize the user interface generator 614 to generate user interfaces and/or notifications (or alerts) to a user device. For example, the user interface generator 614 may utilize data from the response monitor 610 (e.g., collected data, report formatting data, etc.) to generate a graphical user interface representative of the real-time view described above in connection with the response monitor 610. In some examples, the user interface generator 614 may generate one or more of an alert, notification, report, graphical user interface, sound (e.g., via a speaker), haptic feedback (e.g., via a vibration motor of a user device), Short Message/Messaging Service (SMS) text, Multimedia Messaging Service (MMS) text, push notifications, and/or any other data object for providing information to a user via a user device. In some examples, the user interface generator 614 may generate and/or transmit push notifications to a companion application associated with the smart routing system 102. The companion application associated with the smart routing system 102 may be installed and/or associated, at least in part, with a user device (e.g., user devices 106A-106N). In some examples, the user interface generator 614 may interact with a user via a bidirectional user-friendly interface to allow the user to specify preferences, view the status of their requests, and/or adjust any other settings for how unified responses are compiled. In some examples, the user interface generator 614 may leverage the credential circuitry 214 (as described herein) to employ various security measures for safeguarding user data and server responses, such as end-to-end encryption, authentication, and/or the like to ensure that any or all unified responses and/or user interface mechanisms are compliant with any or all applicable laws, regulations, corporate policies, third-party standards, predefined rules, and/or any other security protocols.

In some examples, the smart compiler circuitry 212 may utilize the feedback collector 616 to log response data (e.g., received from AI systems in response to task requests, subtask requests, and/or batch files). For example, the feedback collector 616 may generate log entry data in a log database (e.g., of storage device 110 and/or the like) comprising response data, a task request (subtask request, and/or batch file) associated with the response data, a timestamp (e.g., indicating a time of receipt and/or the like), a response origin (e.g., AI system and/or server that provided the response data and/or the like), a destination (e.g., a user that made the request, device that transmitted the request, and/or the like), and/or any other log entry data described herein. In some examples, the feedback collector 616 of the smart compiler circuitry 212 may comprise, at least in part, the feedback collector 514 of the smart router circuitry 210 and/or the feedback collector 404 of the request receiver circuitry 208. In some examples, the feedback collector 616, the feedback collector 514, and/or the feedback collector 404 may utilize, at least in part, the same log database or different log databases. In some examples, any or all data logged by the feedback collector 404 and/or the feedback collector 514 may be accessible to the feedback collector 616, and/or vice versa. The feedback collector 616 may generate log entry data indicating feedback on the performance (e.g., of the apparatus 200 to process the request, the response data from the target AI system, and/or the like) and resource consumption used to process the request (e.g., at the apparatus 200 and/or the target AI system). In some examples, log entry data may be used in conjunction with a feedback loop (e.g., machine learning model, artificial neural network, etc.) to refine future decisions associated with integrating response data into unified responses, and/or other operations associated with one or more modules of the smart compiler circuitry 212. In some examples, after the smart compiler circuitry 212 delivers a unified response to a user device, the feedback collector 616 (e.g., via the user interface generator 614, communications hardware 206, and/or the like) may collect user indicated feedback data (e.g., via a survey, satisfaction rating, emotion recognition algorithm, and/or the like). The smart compiler circuitry 212 may utilize the user indicated feedback data (e.g., via a feedback loop, etc.) to refine operations performed by the apparatus 200 as described herein, such as by updating a sequencing algorithm, prioritizing response times over completeness or another characteristic of a unified response, improving data integration, and/or the like.

Turning to FIG. 2, the apparatus 200 further comprises credential circuitry 214 that may verify one or more credentials associated with a user and/or user device based on a stored credentials associated with an authentic and/or authorized user and/or user device (e.g., of the smart routing system 102). The credential circuitry 214 may utilize processor 202, memory 204, or any other hardware component (e.g., the request authenticator 406, and/or the like) included in the apparatus 200 to perform these operations, as described in connection with FIGS. 7 and 8A-8C below. The credential circuitry 214 may further utilize communications hardware 206 to gather data from a variety of sources (e.g., user devices 106A-106N and/or AI systems 108A-108N, as shown in FIG. 1), and/or exchange data with a user (e.g., setup a user profile or account with the smart routing system 102 and/or a companion application thereof), and in some embodiments may utilize processor 202 and/or memory 204 to verify a user and/or user device with a user profile or account (e.g., before allowing the processing a task request, providing a unified response, etc.). In some embodiments, the credential circuitry 214 may prevent, at least in part, sensitive data (e.g., PII, encrypted data, etc.) associated with a user and/or entity from being transmitted to user devices 106A-106N and/or AI systems 108A-108N. In some examples, the credential circuitry 214 may handle any or all security verification (e.g., handshake protocols, check security certificate validity, and/or the like) associated with transmitting data via the communications network 104.

In addition, the apparatus 200 further comprises geolocation circuitry 216 that generates and/or collects geolocation data (e.g., GPS coordinates, IP address, base station triangulation data, and/or any other data indicative of a physical location). The geolocation circuitry 216 may utilize processor 202, memory 204, or any other hardware component included in the apparatus 200 to perform these operations, as described in connection with FIGS. 7, 8A-8C, 9, and 10A-10C below. The geolocation circuitry 216 may further utilize communications hardware 206 to gather data from a variety of sources (e.g., user devices 106A-106N, AI systems 108A-108N, server farms/clusters, mobile networks, Internet Service Providers (ISP), and/or any other entity associated with a physical computing device), and/or exchange data with a user, and in some embodiments may utilize processor 202 and/or memory 204 to generate geofence boundaries (e.g., based on data exportation laws, regulations, corporate policies, and/or the like). The geolocation circuitry 216 may utilize geolocation mapping services (e.g., Google Maps™, GPS, and/or the like) and/or location data received from one or more user devices 106A-106N to determine a current location of one or more users.

Although components 202-216 are described in part using functional language, it will be understood that the particular implementations necessarily include the use of particular hardware. It should also be understood that certain of these components 202-216 may include similar or common hardware. For example, the request receiver circuitry 208, smart router circuitry 210, smart compiler circuitry 212, credential circuitry 214, and geolocation circuitry 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the request receiver circuitry 208, smart router circuitry 210, smart compiler circuitry 212, credential circuitry 214, and geolocation circuitry 216 may leverage the processor 202, memory 204, or communications hardware 206 as described above, it will be understood that any of the request receiver circuitry 208, smart router circuitry 210, smart compiler circuitry 212, credential circuitry 214, and geolocation circuitry 216 may include one or more dedicated processors, specially configured field programmable gate array (FPGA), or application specific interface circuit (ASIC) to perform its corresponding functions, and may accordingly leverage the processor 202 for executing software stored in a memory (e.g., memory 204), or communications hardware 206 for enabling any functions not performed by special-purpose hardware. In all embodiments, however, it will be understood that the request receiver circuitry 208, smart router circuitry 210, smart compiler circuitry 212, credential circuitry 214, and geolocation circuitry 216 comprise particular machinery designed for performing the functions described herein in connection with such elements of apparatus 200.

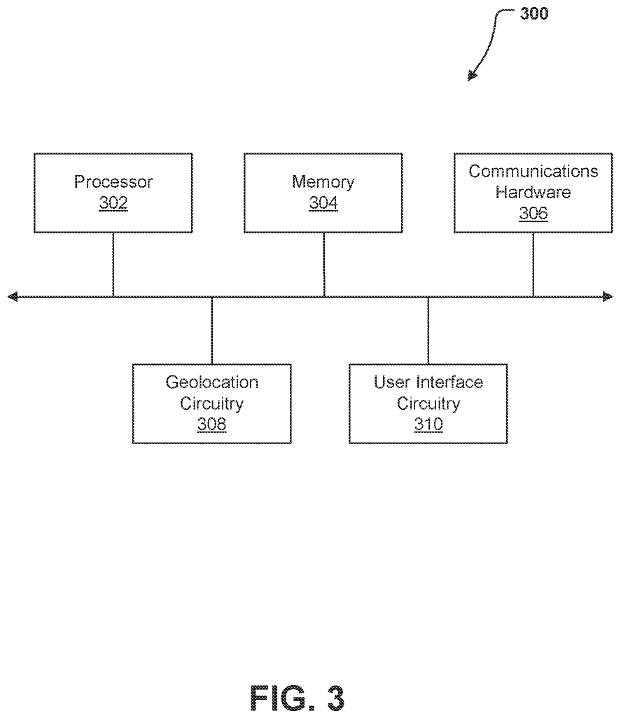

Turning to FIG. 3, as illustrated, an apparatus 300 is shown that represents an example user device (e.g., any of user devices 106A-106N) or an example AI system (e.g., any of AI systems 108A-108N). The apparatus 300 includes processor 302, memory 304, and communications hardware 306, each of which is configured to be similar to the similarly named components described above in connection with FIG. 2.

The apparatus 300 may include geolocation circuitry 308, which includes hardware components (e.g., GPS receiver, mobile network transducer, etc.) designed for communicatively coupling with a satellite-based radio navigation system (e.g., global positioning system (GPS)) and/or a cellular network to determine the current location for the apparatus 300 (e.g., via GPS coordinates, radiolocation through triangulation between base station, or the like). The geolocation circuitry 308 may utilize processor 302, memory 304, or any other hardware component included in the apparatus 300 to perform these operations, as described in connection with FIGS. 7, 8A-8C, 9, and 10A-10C below. The geolocation circuitry 308 may further utilize communications hardware 306 to communicate with navigation systems, cellular (or mobile) networks, and/or apparatus 200, or may otherwise utilize processor 302 and/or memory 304 to generate geolocation data representative of the current location of the apparatus 300. In some embodiments, the geolocation circuitry 308 may identify the location of one or more servers associated with a particular AI system (e.g., AI systems 108A-108N) that are not co-located at the same location but that may each handle a portion of executing an actionable task (or processing a subtask request or the like).

In addition, the apparatus 300 may also include user interface circuitry 310, which includes hardware components designed for receiving user inputs and rendering virtual graphic outputs. The user interface circuitry 310 may utilize processor 302, memory 304, or any other hardware component included in the apparatus 300 to perform these operations, as described in connection with FIGS. 7, 8A-8C, 9, and 10A-10C below. The user interface circuitry 310 may further utilize communications hardware 306 to transmit data representative of a user input and/or receive data to render as a virtual graphics output, or may otherwise utilize processor 302 and/or memory 304 to generate data representative of a user input and/or generate virtual graphics output, e.g., based on received data. The user interface circuitry 310 may comprise one or more of a keyboard, pointing device, touchscreen, microphone with speech recognition interface, camera with gesture-based interface, or other input device capably of receiving various different user inputs. In addition, the user interface circuitry 310 may comprise a display device including one or more of a screen with graphical user interface (GUI), speaker, light emitting diode (LED), haptic technology device, or any other output device capable of rendering information to a user as described herein.

In some embodiments, various components of the apparatus 200 and apparatus 300 may be hosted remotely (e.g., by one or more cloud servers) and thus need not physically reside on the corresponding apparatus (e.g., apparatus 200, apparatus 300, or the like). For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses (e.g., apparatus 200 and apparatus 300), example embodiments are described below in connection with a series of flowcharts.

### Example Operations

Turning to FIGS. 7, 8A-8C, 9, and 10A-10C, example flowcharts are illustrated that contain example operations implemented by example embodiments described herein. The operations illustrated in FIGS. 7, 8A-8C, 9, and 10A-10C may, for example, be performed by a system device (e.g., server, etc.) of the smart routing system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, request receiver circuitry 208, smart router circuitry 210, smart compiler circuitry 212, credential circuitry 214, and geolocation circuitry 216, and/or any combination thereof.

It will be understood that user interaction with the smart routing system 102 may occur directly via communications hardware 206, or may instead be facilitated by a separate user device (e.g., any of user devices 106A-106N shown in FIG. 1, which may in turn be embodied by an apparatus 300, which is shown and described in connection with FIG. 3), as shown in FIG. 1, and which may have similar or equivalent physical componentry facilitating such user interaction. It will be understood that AI system interaction with the smart routing system 102 may occur directly via communications hardware 206, or may instead be facilitated by a separate user device (e.g., one or more servers of any of AI systems 108A-108N shown in FIG. 1, which may in turn be embodied by an apparatus 300, which is shown and described in connection with FIG. 3), as shown in FIG. 1, and which may have similar or equivalent physical componentry facilitating such AI system interaction.

Turning to FIG. 7, example operations are shown for intelligently and/or objectively routing one or more task requests, subtask requests, and/or batch files to one or more AI systems.

As shown by operation 702, the apparatus 200 may include means, such as processor 202, memory 204, communications hardware 206, request receiver circuitry 208, smart router circuitry 210, or the like, for receiving a subtask request that is representative of instructions to execute an actionable subtask. For example, the smart router circuitry 210 may receive one or more subtask requests (e.g., associated with one or more user provided task requests) from the request receiver circuitry 208. Operation 702 is described in further detail below in connection with FIG. 8A.

As shown by operation 704, the apparatus 200 may include means, such as processor 202, memory 204, communications hardware 206, smart router circuitry 210, or the like, for determining computational capabilities associated with one or more AI systems. Operation 702 is described in further detail below in connection with FIG. 8B.

As shown by operation 706, the apparatus 200 may include means, such as processor 202, memory 204, communications hardware 206, smart router circuitry 210, or the like, for matching the subtask request with a target AI system of the one or more AI systems. Operation 702 is described in further detail below in connection with FIG. 8C.

As shown by operation 708, the apparatus 200 may include means, such as processor 202, memory 204, communications hardware 206, smart router circuitry 210, or the like, for causing transmission of the subtask request to the target AI system. In some examples, the operation 708 may include monitoring a communications channel for a reply from one or more AI systems (e.g., to ensure that any or all task requests, subtask requests, and/or batch files were received). In some examples, the operation 708 may include receiving acknowledgment from the one or more AI systems that a subtask request has been received and/or will be acted upon by the AI system. If a confirmation of receipt for any or all task requests, subtask requests, and/or batch files is not received then the operation 708 may include causing retransmission (or rerouting) of the unacknowledged task requests, subtask requests, and/or batch files. In some examples, the operation 708 may include causing transmission (or rerouting) the unacknowledged task requests, subtask requests, and/or batch files a number of times (e.g., for 3 retry attempts, or any other number). In some examples, if an acknowledgment is not received from the first AI system (or first server) after a predefined number for retransmission attempts (or a predefined waiting period) then the operation 708 may include rerouting the unacknowledged task requests, subtask requests, and/or batch files to another AI system, a second server of the first AI system, or the like.

In some embodiments, operation 702 may be performed in accordance with the operations described by FIG. 8A. Turning to FIG. 8A, example operations are shown for receiving and/or processing a task request (e.g., from a user device or the like as desired herein).

As shown by operation 802, the apparatus 200 may include means, such as processor 202, memory 204, communications hardware 206, request receiver circuitry 208, or the like, for monitoring a computing environment for a task request comprising AI system instructions and/or one or more subtask requests. In some examples, the operation 802 may include authenticating that the task request is from an authorized and/or authenticated user device, such as associated with a user and/or user account or profile. In some examples, the operation 802 may include generating log entry data comprising the task request, the subtask request, and/or the authorized device. In some examples, the operation 802 may include removing one or more of unnecessary data, redundant data, or malicious data from the task request. In some examples, the operation 802 may include some or all of the operations or processes described herein for the request receiver circuitry 208.

As shown by operation 804, the apparatus 200 may include means, such as processor 202, memory 204, communications hardware 206, request receiver circuitry 208, or the like, for validating that a task request comprises necessary data that is representative of instructions to execute an actionable task. In some examples, the necessary data defines a required request format, prompt style and/or the like. In some examples, the operation 804 may include determining, based on the necessary data, a categorization for the task request. The categorization for the task request may include one or more of a data retrieval request, a data modification request, a data generation request, and/or the like as described herein. In some examples, the operation 804 may include determining that the task request includes sensitive data (e.g., PII, CCI, trade secrets, etc.) and flagging that sensitive data for removal and/or replacement with synthetic data. In some examples, the operation 804 may include generating synthetic data which is similar to the sensitive data previously flagged. For example, if the sensitive data is a name, date of birth, and home address then the request receiver circuitry 208 (as described herein) may generate a generic or fake name (e.g., John Doe, Jane Doe, etc.), generate a randomized date (e.g., within the same century), and/or generate a generic or fake address (e.g., 123 Name Street, City Town, USA 12345-1234, etc.). In some examples, the operation 804 may include storing the sensitive data to a response cache database (or other database) for later integration into any associated unified response (e.g., to preserve the context of the task request and/or the unified response) and/or replacing the sensitive data with the synthetic data. The sensitive data and the synthetic data may share a common formatting in order to more easily identify how to match the sensitive data with the synthetic data (e.g., in the subtask request to an AI system) or vice versa (e.g., in a unified response to a user device).

As shown by operation 806, the apparatus 200 may include means, such as processor 202, memory 204, communications hardware 206, request receiver circuitry 208, or the like, for segmenting, parsing, and/or slicing (e.g., with a parsing algorithms, slicing algorithm, or the like) a task request (e.g., representative of instructions to execute a multifaceted or complex actionable task and/or other task types described herein) into one or more subtask requests which each represent instructions to execute a respective actionable subtask (e.g., at least at portion of the multifaceted or complex actionable task). In some examples, the operation 806 may include associating each of the one or more subtask requests with tag data. Further, each unit of tag data may represent one or more of a data retrieval subtask, a data modification subtask, a data generation subtask, an AI system type, and/or any other subtask type and/or task type as described herein. In some examples, the operation 806 may include determining for each of the one or more subtask requests a respective time-sensitivity rating and a respective criticality rating. In some examples, the operation 806 may include prioritizing, ordering, and/or sequencing the one or more subtask requests based on one or more of a time-sensitivity rating or a criticality rating.

As shown by operation 808, the apparatus 200 may include means, such as processor 202, memory 204, communications hardware 206, request receiver circuitry 208, or the like, for compiling each of the one or more subtask requests into one or more batch data objects (e.g., encrypted/unencrypted batch files, etc.). Further, each of the one or more batch data objects may comprise necessary data that is associated with each of the one or more subtask requests of a respective batch data object. In some examples, the operation 808 may include establishing a secure communication channel (e.g., a virtual private network (VPN) connection, an end-to-end encryption channel, or another secured communications channel). In some examples, the operation 808 may include monitoring the secure communication channel for transmission errors, corrupted data, malicious data, unauthenticated and/or unauthorized access attempts, and/or the like. In some examples, the operation 808 may include causing transmission of the one or more batch data objects via the secure communication channel. In some examples, the operation 808 may include monitoring for and/or receiving (e.g., at the request receiver circuitry 208) an acknowledgement receipt (e.g., from the smart router circuitry 210) indicating that the one or more subtask request and batch files or data objects have been successfully received (e.g., with all necessary data to route the request(s) and execute the associated task(s)). In some examples, the operation 808 may include performing one or more operations comprising one or more of metric collection, alert notification, and/or report generation as described herein in connection with the apparatus 200.

In some embodiments, operation 704 may be performed in accordance with the operations described by FIG. 8B. Turning to FIG. 8B, example operations are shown for determining computational capabilities associated with one or more AI system.

As shown by operation 810, the apparatus 200 may include means, such as processor 202, memory 204, communications hardware 206, smart router circuitry 210, or the like, for detecting a language (e.g., a spoken language, written language, sign language, coding or programming language, and/or the like) associated with the subtask request. In some examples, the operation 810 may include identifying, using speech recognition techniques, a spoken language (e.g., English, Japanese, Italian, etc.) of a task request, subtask request, and/or batch file, which comprises a recorded voice request (e.g., in an audio data object). In some examples, the operation 810 may include identifying, using natural language processing techniques, a written language (e.g., English, Japanese, Italian, etc.) of a task request, subtask request, and/or batch file, which comprises a text request (e.g., in a text data object).

As shown by operation 812, the apparatus 200 may include means, such as processor 202, memory 204, communications hardware 206, smart router circuitry 210, or the like, for evaluating or assessing a subtask request (or the like) to determine the computational capabilities (e.g., minimum processing power, memory, etc.) required for a respective AI system to execute one or more actionable tasks of the subtask request. Further, the smart router circuitry 210 may access or retrieve data from a computational profile database to determine one or more AI systems (e.g. based on a respective computational profile of each AI system) which may include the necessary computational capabilities to process the subtask request (or the like).

As shown by operation 814, the apparatus 200 may include means, such as processor 202, memory 204, communications hardware 206, smart router circuitry 210, or the like, for evaluating or assessing a computational profile associated with each of the one or more AI systems (e.g., to identify one or more criteria, metrics, characteristics, preferences, and/or compliance statuses associated with the AI system and/or a server thereof). In some such examples, a respective computational profile may comprise one or more of processing data, memory data or storage data, networking data, timing data, current load data, expected availability data, total capacity data, geolocation data, security data, and/or any other data associated with an AI system, and/or any other data collected (or recorded) by the apparatus 200 as described herein.

In some embodiments, operation 706 may be performed in accordance with the operations described by FIG. 8C. Turning to FIG. 8C, example operations are shown for matching the subtask request with a target AI system of the one or more AI systems.

As shown by operation 816, the apparatus 200 may include means, such as processor 202, memory 204, communications hardware 206, smart router circuitry 210, or the like, for determining an optimized or intelligent routing (e.g., a network routing to a particular AI system and/or server), based on one or more criteria (e.g., metrics, characteristics, preferences, laws, etc.), for the subtask request to the one or more AI systems. In some examples, one or more criteria, characteristics, etc., may relate to one or more AI systems and/or servers thereof. For example, an optimized routing may be selected based on a user preference for the quickest response time, in which case the AI system and/or server with the fastest available response time (e.g., based on real-time or near-real-time network monitoring) would be selected. As another example, an optimized routing may be selected based on a user preference for the lowest cost (e.g., in the case of paid AI systems), in which case the AI system and/or server with the lowest cost (e.g., indicated in a respective profile) would be selected. As another example, an optimized routing may be selected based on a user preference for the best response quality in which case the most specialized AI system (e.g., for a particular subtask) would be selected. As another example, an optimized routing may be selected based on a user preference for the best response quality in which case the most specialized AI system (e.g., for a particular subtask) would be selected. As another example, an optimized routing may be selected based on a legal requirement and/or corporate policy associated with data export controls in which case an AI system (and/or a particular server thereof) may be selected (e.g., based on an associated geolocation and/or compliance status for handling sensitive data which the apparatus 200 may determine from a computational profile of the AI system and/or another database as described herein).

As shown by operation 818, the apparatus 200 may include means, such as processor 202, memory 204, communications hardware 206, smart router circuitry 210, or the like, for matching a processor-intensive subtask request with a computational profile indicating a processor-intensive metric (or other data indicating strong processing capabilities, such as a processor model, a total number of available CPUs and/or GPUs, or the like). In some examples, the operation 818 may include matching a memory-intensive subtask request with a computational profile indicating a memory-intensive metric (or other data indicating a large amount of memory capabilities, such as a memory type, usable quantity, model, or the like). In some examples, the operation 818 may include matching a network-intensive subtask request with a computational profile indicating an optimized network routing metric (or other data indicating a high amount of network bandwidth, such as network transfer speeds, a fiberoptic Internet connection, or the like). In some examples, the operation 818 may include matching a compliance restricted subtask request with a computational profile indicating a compliance status metric (or other data indicating that the AI system or at least a server thereof is compliant with any or all necessary compliance requirements, such as geolocation, security standard, or the like as described herein.).

Turning to FIG. 9, example operations are shown for intelligently and/or objectively compiling one or more AI system outputs or responses (e.g., response data, response data objects, etc.) into a unified response (e.g., associated with one or more task requests, subtask requests, and/or batch files).

As shown by operation 902, the apparatus 200 may include means, such as processor 202, memory 204, communications hardware 206, smart compiler circuitry 212, or the like, for receiving response data that is representative of one or more AI system outputs. For example, an AI system may provide response data to the apparatus 200 in response to subtask request (or the like) provided to the AI system by the apparatus 200. Operation 902 is described in further detail below in connection with FIGS. 10A-10B.

As shown by operation 904, the apparatus 200 may include means, such as processor 202, memory 204, communications hardware 206, smart compiler circuitry 212, or the like, for identifying a task request associated with the response data. In some examples, the task request comprises one or more subtask requests, sensitive data and/or the like as described herein. In some examples, the operation 904 may include retrieving and/or accessing log entry data in a log database (e.g., of storage device 110 and/or the like) comprising the task request, a timestamp (e.g., indicating a time of receipt and/or the like), a request origin (e.g., user that made the request, device that transmitted the request, and/or the like) and/or any other data generated by a feedback collector (e.g., feedback collector 404 and/or the like as described herein). In some examples, the task request (or the like) may be identified based on the retrieved log entry data and/or any identifiable information included with, or in, the response data. For example, the log entry data may include a request identifier (e.g., token, number, code, signature, etc.) that corresponds to the response data. For example, the AI system may be provided with the request identifier by the smart router circuitry 210 along with any task request, subtask request, or the like (e.g., at the operation 708 as described above or during any other data exchange between the apparatus 200 and the AI system). Further, the request to the AI system may include instructions (in addition to the actionable task instructions) indicating that the AI system should identify any or all response data with the request identifier.

As shown by operation 906, the apparatus 200 may include means, such as processor 202, memory 204, communications hardware 206, smart compiler circuitry 212, or the like, for generating a unified response associated with the task request. In some examples, the unified response may comprise the response data (e.g., predictions, recommendations, images, audio files, videos, and/or the like as described herein), sensitive data (e.g., not included in the response data), and/or any other contextual data (e.g., preserved at least in part by the context preserver 612 as described herein). For example, the smart compiler circuitry 212 may replace synthetic data or fake data included in the response data from the AI system with sensitive data included in the original task request received from a user device. Operation 906 is described in further detail below in connection with FIG. 10C.

As shown by operation 908, the apparatus 200 may include means, such as processor 202, memory 204, communications hardware 206, smart compiler circuitry 212, credential circuitry 214, or the like, for causing transmission of the unified response to a user device associated with the task request. For example, the smart compiler circuitry 212 may leverage the communications hardware 206 for establishing a secure communication channel (e.g., a virtual private network (VPN) connection, an end-to-end encryption channel, or another secured communications channel) with the user device which provided the original task request. In some examples, the operation 908 may include monitoring the secure communication channel for transmission errors, corrupted data, malicious data, unauthenticated and/or unauthorized access attempts, and/or the like. In some examples, the operation 908 may include reauthenticating (e.g., by leveraging the request authenticator 406 and/or the credential circuitry 214 to perform one or more authentication and/or authorization processes as described herein) the user device before causing transmission of the unified response data. In some examples, the operation 908 may include causing transmission of the one or more unified responses and/or any additional data (e.g., images, videos, links, etc.) via the secure communication channel. In some examples, the operation 908 may include monitoring for, and/or receiving, an acknowledgement receipt and/or any user indicated feedback data (e.g., surveys and/or the like as described herein) from the user device.

In some embodiments, operation 902 may be performed in accordance with the operations described by FIG. 10A. Turning to FIG. 10A, example operations are shown for receiving response data from one or more AI systems and/or one or more AI servers.

As shown by operation 1002, the apparatus 200 may include means, such as processor 202, memory 204, communications hardware 206, smart compiler circuitry 212, or the like, for determining an AI system (or one or more servers thereof) that transmitted and/or generated the response data. In some examples, determining of the AI system or server(s) may be based, at least in part, on the response data, a request identifier, computational profile data associated with the AI system (and any or all servers associated therewith, an IP address, and/or any other information as described herein that could be used to identify a particular computing device. For example, an AI system server may transmit the response data to the apparatus 200 via a secured communicational channel that was specifically established for that request and response communication and, thus, the apparatus 200 may identify the AI system and/or a particular server based, at least in part, on the particular communication channel used to receive the response data. In some examples, the request to the AI system may include instructions (in addition to the actionable task instructions and any other instructions provided in the request) indicating that the AI system should identify any or all servers used to generate, transmit (or relay) response data with a server identifier (e.g., IP address, MAC address, serial number, geolocation data, and/or any other data that may identify a computing device).

As shown by operation 1004, the apparatus 200 may include means, such as processor 202, memory 204, communications hardware 206, smart compiler circuitry 212, or the like, for determining timing data that is representative of a response time interval associated with the response data. In some examples, determining timing data (e.g., timestamp data as described herein) may be based, at least in part, on the response data, feedback data (e.g., log entries provided by feedback collector 404 or the like as described herein), and/or metric data as described herein. For example, the response data may comprise timestamp data indicating when the response data was generated by the AI system, the processing time at the AI system (e.g., how long the request took to process, etc.), and/or the like. In some examples, the response data may be matched with a task request (e.g., a timestamp indicating a receipt time, and/or the like) and/or one or more subtask requests (e.g., a timestamp indication to a transmission time, and/or the like) in order to determine various time periods (e.g., differences between timestamps to calculate processing times).

As shown by operation 1006, the apparatus 200 may include means, such as processor 202, memory 204, communications hardware 206, smart compiler circuitry 212, or the like, for determining that the response data comprises a complete response to one or more subtask requests. In some examples, the operation 1006 may include comparing the response data (e.g., upon receipt of some or all response data associated with a task request) to previously received response data and/or similar task request and/or subtask request data to validate the response data. For example, the apparatus 200 may identify each task or subtask of a task request (or the like) and match each subtask with an item of the response data, if a task or subtask cannot be matched to an item of the response data then the apparatus 200 (e.g., via smart compiler circuitry 212) may determine that the response is incomplete.

As shown by operation 1008, the apparatus 200 may include means, such as processor 202, memory 204, communications hardware 206, smart compiler circuitry 212, or the like, for determining that the response data is clean from one or more of data errors, corrupt data, or malicious data. For example, the operation 1006 may include validating the integrity of response data by scanning the response data (e.g., antivirus software, or the like to check for malicious code, trojans, viruses, and/or the like. In some examples, the operation 1006 may include validating the data structure of the response data by scanning for corrupt or broken data, errors (e.g., syntax errors, etc.), and/or the like.

As shown by operation 1010, the apparatus 200 may include means, such as processor 202, memory 204, communications hardware 206, smart compiler circuitry 212, or the like, for generating log entry data comprising one or more of the response data, the task request, the AI system server, the timing data, response completeness data, cleanliness data, and the user device. In some examples, the operation 1010 may include performing one or more processes and/or operations as described herein in connection with the feedback collector 616 and/or the like.

In some embodiments, operation 902 may be performed in accordance with the operations described by FIG. 10B. Turning to FIG. 10B, example operations are shown for responding to a failed response from an AI system.

As shown by operation 1012, the apparatus 200 may include means, such as processor 202, memory 204, communications hardware 206, smart compiler circuitry 212, or the like, for detecting a failed response indication associated with a task request, a subtask request, and/or a batch file. For example, the apparatus 200 may provide a subtask request (or the like) to an AI system and in response the AI system, a computing network, or a server (e.g., relay server, AI system server, ISP server, etc.) may provide a failed response indication to the apparatus 200. In some examples, a failed response indication may include an error notification, such as a failed connection, a transmission timeout notification, and/or any other notification or indication that the subtask request (or the like) was not received, or cannot be processed, by the AI system and/or an AI system server. In some examples, a failed response indication may be generated by the apparatus 200 in response to detection of malicious code, errors, and/or the like in response data from an AI system. In some examples, the operation 1012 may include detecting a failed response indication associated with the task request and/or an AI system server. Further, the failed response indication may be detectable based on one or more of (i) determining that the response data is incomplete, (ii) determining that the response data is corrupt, (iii) determining that the response data was not received within a response time threshold (e.g., less than or equal 30 seconds, 5 minutes, or any other number), and/or any other conditions for detecting a failed communication between computing devices as described herein.

As shown by operation 1014, the apparatus 200 may include means, such as processor 202, memory 204, communications hardware 206, smart compiler circuitry 212, or the like, for causing transmission of a task request, a subtask request, and/or a batch file associated with the failed response indication (e.g., to the same AI system and/or server, to a backup server of the AI system, to another AI system, and/or any other rerouting destination). For example, in the event a failed response indication is detected as described above, then the operation 1014 may include flagging the response data (e.g., with corruptions, errors, etc.), the failed response indication, and/or any associated subtask requests (or the like) for rerouting a subtask request to a backup AI system and/or redundancy server, and/or any other fallback mechanism described herein. In some examples, the operation 1014 may include retrieving and/or using substitute response data (e.g., from the response cache 606) in place of the failed or missing response data (e.g., with corruptions, errors, etc.).

As shown by operation 1016, the apparatus 200 may include means, such as processor 202, memory 204, communications hardware 206, smart compiler circuitry 212, or the like, for generating an error notification indicating that the task request or a subtask request was unsuccessful. In some examples, the operation 1016 may include generating a unified response using substitute response data (e.g., from the response cache 606) in place of the failed or missing response data (e.g., with corruptions, errors, etc.). In some examples, the operation 1016 may include generating a partial response error notification. In some examples, the operation 1016 may include generating a partial unified response (e.g., that only fulfills part of a user's task request). In some examples, the operation 1016 may include causing a user interface to render a partial response error notification to a user via a user device and/or user interface (e.g., using the user interface generator 614 as described above). In some examples, the operation 1016 may include generating a unified response that further comprises generating a partial unified response to the task request, subtask request, or the like. In some examples, the partial unified response comprises an error notification indicating to the user device that, at least in part, the task request, subtask request, and/or the like was unsuccessful (e.g., due to errors, viruses, failed transmission attempts, etc.).

In some embodiments, operation 906 may be performed in accordance with the operations described by FIG. 10C. Turning to FIG. 10C, example operations are shown for generating a unified response.

As shown by operation 1018, the apparatus 200 may include means, such as processor 202, memory 204, communications hardware 206, smart compiler circuitry 212, or the like, for determining a logical sequence for integrating the response data into the unified response to the task request. In some examples, determining a logical sequence is based, at least in part, on one or more of a predefined rule, a response compiler model, a real-time analysis of a user interface of the user device, and/or the like as described herein.

As shown by operation 1020, the apparatus 200 may include means, such as processor 202, memory 204, communications hardware 206, smart compiler circuitry 212, or the like, for integrating (e.g., based on a logical sequence determined at operation 1018 or the like as described herein) any or all response data (e.g., associated with a task request) into a unified response. In some examples, a unified response comprising a response format. In some examples, the operation 1020 may include merging, appending, and/or combining one or more AI system outputs (or response data) into a coherent unified dataset (e.g., with a particular response format, such as a written response to a user's question, a particular file type requested by the user, predefined by a user interface such as a chat session, a companion application, and/or the like). In some examples, the operation 1020 may include using one or more of a predefined rule set, artificial neural network (or the like), sequencing algorithm, or any other algorithm(s) for determining the nature of a task request (or the like) and/or for integrating any or all response data into a logical sequence to response to the task request.

As shown by operation 1022, the apparatus 200 may include means, such as processor 202, memory 204, communications hardware 206, smart compiler circuitry 212, or the like, for determining, by using one or more optimization algorithms, that the unified response is within one or more of a maximum size threshold and/or a format parameter threshold. In some examples, a maximum size threshold may comprise a maximum data object size (e.g., equal to or less than one gigabyte, or any other number). In some examples, a format parameter threshold may comprise a file type (e.g., image file type, video file type, audio file type, etc.), a list of particular words or characters for use in a chat session, and/or any other formatting and/or user interface parameters as described herein. In some examples, the operation 1022 may include applying optimization algorithms (e.g., compression algorithms, etc.) to ensure that the unified response is efficiently compiled (e.g., to minimize any associated data object size(s), increase transmission speed, reduce redundant data such as formatting, increase ease of handing by a user device, and/or the like). In some examples, the operation 1022 may include removing redundant data from a unified response and/or a unified response data object.

As shown by operation 1024, the apparatus 200 may include means, such as processor 202, memory 204, communications hardware 206, smart compiler circuitry 212, or the like, for determining that the task request includes contextual data. In some examples, the operation 1024 may include determining that the task request includes contextual data comprising one or more of a user identifier, a device identifier, session data, or timestamp data. In some examples, the operation 1024 may include determining, based on the contextual data of an associated task request that a unified response is required to include the same or similar contextual data. In some examples, the operation 1024 may include restoring any or all contextual data (e.g., sensitive data, etc.), that may have been removed from a subtask request (or the like) before transmitting the subtask request to an AI system. For example, a user may provide a task request requesting a personal biographic essay and the task request may comprise sensitive data (e.g., personal life details, PII, and/or the like) to assist an AI system to execute the task. In some such examples, the sensitive data may have been removed and replaced with synthetic or substitute data (as described herein). In some examples, the operation 1024 may include identifying any or all synthetic data and/or substitute data in response data and/or in a unified response.

As shown by operation 1026, the apparatus 200 may include means, such as processor 202, memory 204, communications hardware 206, smart compiler circuitry 212, or the like, for integrating, by the smart compiler circuitry, the contextual data and/or data of the task request into the unified response. In some examples, the operation 1026 may include replacing the identified synthetic data and/or substitute data (as described above at operation 1024) with the original sensitive data (e.g., personal life details, PII, and/or the like) provided by the user (e.g., via the original task request). To this end, the apparatus 200 may ensure that the context of the original task request is preserved in the final unified response to the user without compromising the security of the sensitive data.

FIGS. 7, 8A-8C, 9, and 10A-10C illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable the improved routing of task requests to AI systems and/or the improved compiling of various AI system outputs (or response data) into a unified response. Example embodiments thus provide tools that overcome the problems faced by conventional subjective, and/or manual, systems for requesting a response from an AI system. By avoiding the need for users to: (i) directly interface which each AI system individually, (ii) possess a deep understanding of each available AI system, and/or (iii) have a clear understanding of the unique requirements for utilizing each AI system effectively (e.g., prompting, uploading data, available computational resources, etc.), example embodiments thus reduce processing times and/or computational resource usage, while also eliminating the possibility of human error that has been unavoidable with conventional subjective, and/or manual, systems. Further, by providing improved systems and methods of oversight for entities (e.g., corporations, etc.) to monitor and control the usage of AI systems, example embodiments thus reduce the risk associated with the usage of AI systems (e.g., receiving malicious or corrupt response, leaking sensitive data, etc.). Furthermore, embodiments described herein provide additional layers of security and authentication to prevent users from (intentionally or accidently) sharing sensitive data with AI systems and prevent bad actors (e.g., hackers, criminals, etc.) from providing malicious and/or corrupt response data to an entity's computing infrastructure.

Moreover, some example embodiments convert non-standardized user request data (e.g., a user entered task request and/or unstructured user input data) into a standardized format, such as a particular subtask request format which is optimized for a specific AI system's prompt style. In addition, some example embodiments convert non-standardized response data from various AI systems into a standardized format, such as a coherent unified response, slideshow presentation, and/or the like as described herein. Finally, by automating functionality that has historically required human analysis (and/or by providing additional functionality absent from conventional systems), the speed and consistency of the evaluations performed by example embodiments unlocks many potential new functions that have historically not been available, such as the ability to reuse cached response data to complete current response data sets and/or the ability to generate a partial response if certain subtasks are not completed.

As these examples all illustrate, example embodiments contemplated herein provide technical solutions that solve real-world problems faced by entities that seek to efficiently and securely utilize AI systems and/or other digital resources. And while users and AI systems have struggled with how to efficiently and securely combine the strengths of various AI algorithms and models for years, the recently exploding amount of data made available by the recently emerging interconnected AI technologies of today have made this problem significantly more acute, as the expectations of digital security/privacy and user friendly AI systems has grown traditional systems have failed to keep up with these expectations. At the same time, the recently arising ubiquity of mobile devices, GPS tracking, and secured digital communication has unlocked new avenues for solving these problems that have not historically been available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for compiling AI system outputs into unified responses, the method comprising:
receiving, by smart compiler circuitry, response data that is representative of one or more AI system outputs;
identifying, by the smart compiler circuitry, a task request associated with the response data, wherein the task request comprises a subtask request;
generating, by the smart compiler circuitry, a unified response associated with the task request, wherein the unified response comprises the response data; and
causing, by communications hardware, transmission of the unified response to a user device associated with the task request.

2. The method of claim 1, wherein receiving the response data further comprises:
determining, by the smart compiler circuitry and based on the response data, an AI system server that transmitted the response data;
determining, by the smart compiler circuitry and based on the response data, timing data that is representative of a response time interval associated with the response data;
determining, by the smart compiler circuitry, that the response data comprises a complete response to one or more subtask requests;
determining, by the smart compiler circuitry, that the response data is clean from one or more of data errors, corrupt data, or malicious data; and
generating, by the smart compiler circuitry, log entry data comprising one or more of the response data, the task request, the AI system server, the timing data, response completeness data, cleanliness data, and the user device.

3. The method of claim 1, wherein receiving the response data further comprises:
detecting, by the smart compiler circuitry, a failed response indication associated with the task request and an AI system server, wherein the failed response indication is detected based on one or more of (i) determining that the response data is incomplete, (ii) determining that the response data is corrupt, or (iii) determining that the response data was not received within a response time threshold.

4. The method of claim 3, wherein receiving the response data further comprises causing, by the communications hardware, transmission of the task request associated with the failed response indication to one or more of an AI system backup server or smart router circuitry; and
wherein generating the unified response further comprises generating a partial unified response to the task request, wherein the partial unified response comprises an error notification indicating to the user device that, at least in part, the task request was unsuccessful.

5. The method of claim 1, wherein generating the unified response further comprises:
determining, by the smart compiler circuitry, a logical sequence for integrating the response data into the unified response to the task request, wherein determining the logical sequence is based on one or more of a predefined rule, a response compiler model, or a real-time analysis of a user interface of the user device.

6. The method of claim 1, wherein generating the unified response further comprises:
integrating, by the smart compiler circuitry and based on a logical sequence, the response data into the unified response comprising a response format; and
determining, by the smart compiler circuitry and using one or more optimization algorithms, that the unified response is within one or more of a maximum size threshold or a format parameter threshold.

7. The method of claim 1, wherein generating the unified response further comprises:
determining, by the smart compiler circuitry, that the task request includes contextual data comprising one or more of a user identifier, a device identifier, session data, or timestamp data; and
integrating, by the smart compiler circuitry, the contextual data of the task request into the unified response.

8. An apparatus for compiling AI system outputs into unified responses, the apparatus comprising:
smart compiler circuitry configured to:
receive response data that is representative of one or more AI system outputs,
identify a task request associated with the response data, wherein the task request comprises a subtask request,
generate a unified response associated with the task request, wherein the unified response comprises the response data; and
communications hardware configured to:
cause transmission of the unified response to a user device associated with the task request.

9. The apparatus of claim 8, wherein the smart compiler circuitry is further configured to:
determine, based on the response data, an AI system server that transmitted the response data;
determine, based on the response data, timing data that is representative of a response time interval associated with the response data;
determine that the response data comprises a complete response to one or more subtask requests;
determine that the response data is clean from one or more of data errors, corrupt data, or malicious data; and
generate log entry data comprising one or more of the response data, the task request, the AI system server, the timing data, response completeness data, cleanliness data, and the user device.

10. The apparatus of claim 8, wherein the smart compiler circuitry is further configured to detect a failed response indication associated with the task request and an AI system server, wherein the failed response indication is detected based on one or more of (i) determining that the response data is incomplete, (ii) determining that the response data is corrupt, or (iii) determining that the response data was not received within a response time threshold.

11. The apparatus of claim 10, wherein the communications hardware is further configured to cause transmission of the task request associated with the failed response indication to one or more of an AI system backup server or smart router circuitry; and
wherein the smart compiler circuitry is further configured to generate a partial unified response to the task request, wherein the partial unified response comprises an error notification indicating to the user device that, at least in part, the task request was unsuccessful.

12. The apparatus of claim 8, wherein the smart compiler circuitry is further configured to determine a logical sequence for integrating the response data into the unified response to the task request, wherein determining the logical sequence is based on one or more of a predefined rule, a response compiler model, or a real-time analysis of a user interface of the user device.

13. The apparatus of claim 8, wherein the smart compiler circuitry is further configured to:
integrate, based on a logical sequence, the response data into the unified response comprising a response format; and
determine that the unified response is within one or more of a maximum size threshold or a format parameter threshold.

14. The apparatus of claim 8, wherein the smart compiler circuitry is further configured to:
determine that the task request includes contextual data comprising one or more of a user identifier, a device identifier, session data, or timestamp data; and
integrate the contextual data of the task request into the unified response.

15. A computer program product for compiling AI system outputs into unified responses, the computer program product comprising at least one non-transitory computer-readable storage medium storing software instructions that, when executed, cause an apparatus to:
receive response data that is representative of one or more AI system outputs;
identify a task request associated with the response data, wherein the task request comprises a subtask request;
generate a unified response associated with the task request, wherein the unified response comprises the response data; and
cause transmission of the unified response to a user device associated with the task request.

16. The computer program product of claim 15, wherein the software instructions, when executed, further cause the apparatus to:
determine, based on the response data, an AI system server that transmitted the response data;
determine, based on the response data, timing data that is representative of a response time interval associated with the response data;
determine that the response data comprises a complete response to one or more subtask requests;
determine that the response data is clean from one or more of data errors, corrupt data, or malicious data; and
generate log entry data comprising one or more of the response data, the task request, the AI system server, the timing data, response completeness data, cleanliness data, and the user device.

17. The computer program product of claim 15, wherein the software instructions, when executed, further cause the apparatus to: detect a failed response indication associated with the task request and an AI system server, wherein the failed response indication is detected based on one or more of (i) determining that the response data is incomplete, (ii) determining that the response data is corrupt, or (iii) determining that the response data was not received within a response time threshold.

18. The computer program product of claim 17, wherein the software instructions, when executed, further cause the apparatus to:
cause transmission of the task request associated with the failed response indication to one or more of an AI system backup server or smart router circuitry; and
generate a partial unified response to the task request, wherein the partial unified response comprises an error notification indicating to the user device that, at least in part, the task request was unsuccessful.

19. The computer program product of claim 15, wherein the software instructions, when executed, further cause the apparatus to determine a logical sequence for integrating the response data into the unified response to the task request, wherein determining the logical sequence is based on one or more of a predefined rule, a response compiler model, or a real-time analysis of a user interface of the user device.

20. The computer program product of claim 15, wherein the software instructions, when executed, further cause the apparatus to:
integrate, based on a logical sequence, the response data into the unified response comprising a response format; and
determine that the unified response is within one or more of a maximum size threshold or a format parameter threshold.
